(19) United States
(12) Patent Application Publication
(10) Pub. No.: US 2023/0078039 A1
(43) Pub. Date: Mar. 16, 2023

(54) ROTATING ELECTRICAL MACHINE AND PRODUCTION METHOD THEREOF

(71) Applicant: DENSO CORPORATION, Kariya-city (JP)

(72) Inventors: Kazuya IWASE, Kariya-city (JP); Takehiro ISHIBASHI, Kariya-city (JP); Youhei KOYAMA, Kariya-city (JP); Hiromichi MORIOKU, Kariya-city (JP)

(73) Assignee: DENSO CORPORATION, Kariya-city (JP)

(21) Appl. No.: 17/990,078

(22) Filed: Nov. 18, 2022

Related U.S. Application Data
(63) Continuation of application No. PCT/JP2021/018394, filed on May 14, 2021.

(30) Foreign Application Priority Data
May 18, 2020 (JP) 2020-087010

(51) Int. Cl. H02K 3/28; H02K 15/04

(52) U.S. Cl. CPC H02K 3/28; H02K 15/0414; H02K 2215/00; H02K 2203/12

(57) ABSTRACT

An armature winding includes a plurality of winding segments each of which is made of a winding of a conductor wire member. The winding segments are arranged at a given interval away from each other in a circumferential direction of the armature winding and face a magnet unit. Each of the conductor wire members is made of a bundle of a plurality of wires. Each winding segment includes a pair of straight portions and link portions. The straight portions extend straight in an axial direction of a rotor. The link portion connect the straight portions together. Each of the straight portions is made of turns of the conductor wire member which are arranged in the form of multiple columns and layers. Each link portion is shaped to have a space factor lower than those in the straight portions of the winding segment.

### CROSS REFERENCE TO RELATED DOCUMENT

The present application claims the benefit of priority of Japanese Patent Applications No. 2020-087010 filed on May 18, 2020, the disclosure of which is incorporated in its entirety herein by reference.

### TECHNICAL FIELD

This disclosure generally relates to a rotating electrical machine and a production method thereof.

### BACKGROUND

In the past, rotating electrical machines have been known which include a rotor and an armature (see first and second patent literatures). The rotor has a plurality of magnetic poles whose polarities alternate in a circumferential direction of the rotor. The armature includes a multi-phase armature winding which is made of a conductor wound in a concentrated manner. The armature winding of the rotating electrical machine taught in the second patent literature is produced by preparing a bundle of fine conductive wires and winding the bundle in multiple columns of turns and multiple layers of the turns, thereby minimizing a risk of occurrence of eddy current.

### PRIOR ART DOCUMENT

### Patent Literature

FIRST PATENT LITERATURE Japanese Patent First Publication No. 1999-206054
SECOND PATENT LITERATURE Japanese Patent First Publication No. 2004-208464

### SUMMARY OF THE INVENTION

Typical armature windings include pairs of straight portions facing a magnet unit of a rotor in a radial direction of the armature winding and link portions (i.e., coil ends) each of which extends in a circumferential direction of the armature winding to connect the paired straight portions. The straight portions are shaped to extend straight in an axial direction of the armature winding. The link portions are each formed in substantially an arc-shape. Consequently, when the straight portions are arranged in multiple columns of turns and multiple layers of the turns, the degree of curve or orientation of the link portions will result in disorder or incorrect orientation of the straight portions, which leads to formation of air gaps between the straight portions. This encounters a risk that the space factor (also called stacking factor) of the straight portions of the armature winding may be reduced.

This disclosure was made in view of the above problem. It is a principal object of this disclosure to provide a rotating electrical machine which is capable of improving a space factor (also called stacking factor) of straight portions of an armature winding and a production method of such a rotating electrical machine.

The first means to solve the above problem is to provide a rotating electrical machine which comprises: (a) a magnetic field-producing unit including a magnet unit which is equipped with a plurality of magnetic poles whose polarities alternate in a circumferential direction of the magnet unit; (b) an armature which includes a multi-phase armature winding; and (c) a rotor which is implemented by one of the magnetic field-producing unit and the armature. The armature winding includes a plurality of winding segments each of which is made of a winding of a conductor wire member. The winding segments are arranged at a given interval away from each other in the circumferential direction and facing the magnet unit. Each of the conductor wire members is made of a bundle of a plurality of wires. Each of the winding segments includes a pair of straight portions and a pair of link portions. The straight portions extend straight in an axial direction of the rotor. The link portions connect the straight portions together. Each of the straight portions includes turns of the conductor wire member which are arranged in multiple columns and layers. Each of the link portions is configured to have a space factor lower than those in the straight portions.

Each of the link portions is used to connect between the paired straight portions. Each of the link portions is, therefore, shaped to have some portion(s) which bend from the axial direction to the circumferential direction. Each of the link portions is made up of a plurality of turns of the conductor wire member. Bending a portion of the link portion may, therefore, cause incorrect orientation or deformation of the turns of the conductor wire member which form the link portion to be transmitted to the straight portions, thereby resulting in disorder of the turns of the conductor wire member which form the straight portions, which will lead to air gaps among the turns. Such a phenomenon usually prominently appears in the conductor wire member made of a bundle of wires. It is also experientially found that the above phenomenon will occur in a case where the turns of the conductor wire member are arranged in close contact with each other in the link portions.

In the above first means, the link portions of each winding segment are each designed to have a space factor lower than those of the straight portions. In other words, the conductor wire member is wound more loosely in the link portions than in the straight portions in order to minimize the transmission of incorrect orientation or deformation of the turns of the conductor wire member from the link portions to the straight portions continuing from the link portions. This enables the conductor wire member to be wound tightly in the straight portions to eliminate air gaps among the turns of the conductor wire member in the straight portion, thereby resulting in an increase in space factor in the straight portions facing the magnet unit. Further, the link portions have increased sizes of air gaps among the turns of the conductor wire member, thereby enhancing the cooling of the link portions using air or water.

The second means is to provide the rotating electrical machine in the first means wherein each of the link portions is curved from end to end thereof.

The above configuration results in an increased radius of curvature of the link portions which is larger than that in the case where the link portions are only partially curved or bent, which minimizes the transmission of the incorrect orientation or deformation of the turns of the conductor wire member from the link portions to the straight portions and enables the conductor wire member to be wound tightly to have increased numbers of columns and layers of turns in the straight portions.

The third means is to provide the rotating electrical machine in the first or second means wherein each of the link portions has a dimension, as defined in a radial direction, which is larger than those of the straight portions.

The above dimensional relation results in a decrease in size of the winding segments in the axial direction and also enables the link portions to have a decreased space factor.

The fourth means is to provide the rotating electrical machine in the first or second means wherein each of the conductor wire members has a rectangular cross section, and the turns of the conductor wire member are arranged adjacent to each other in contact between sides thereof in each of the straight portions.

The above configuration results in a decreased size of air gaps among the turns of the conductor wire member in the straight portions as compared with the case where the conductor wire member is shaped to have a circular transverse section. This enables the space factors in the straight portions to be increased.

The fifth means is to provide a production method of a rotating electrical machine which includes a magnetic field-producing unit equipped with a magnet unit which has a plurality of magnetic poles whose polarities alternate in a circumferential direction of the magnet unit, an armature which includes a multi-phase armature winding, and a rotor which is implemented by one of the magnetic field-producing unit and the armature. The production method comprises: (a) a conductor making process which collects a plurality of wires in the form of a bundle to produce each conductor wire member; (b) a winding segment making process which winds each of the conductor wire members around a winding bobbin multiple times to produce each winding segment; and (c) an armature winding producing process which arranges the winding segments in a circumferential direction of the rotor and connects the winding segments to produce the armature winding. The winding bobbin includes a cylinder and a pair of flanges which are disposed on opposed ends of the cylinder to have a side surface of the cylinder arranged between the flanges. The side surface of the cylinder includes a pair of flat surfaces which are opposed to each other and a pair of end surfaces each which connects an end of a first one of the flat surfaces and an end of a second one of the flat surfaces. A distance between portions of the flanges which coincide with the end surfaces of the cylinder is longer than that between portions of the flanges which coincide with each of the flat surfaces.

The conductor wire member is wound around the cylinder of the winding bobbin to produce each of the winding segments which includes the pair of straight portions extending straight on the flat surfaces of the winding bobbin and the link portions connecting the straight portions together. Each of the link portions is, therefore, shaped to have some portion(s) which bend. Each of the link portions is made up of a plurality of turns of the conductor wire member. Bending a portion of the link portion, therefore, faces a risk that incorrect orientation or deformation of the turns of the conductor wire member which form the link portion may be transmitted to the straight portions, thereby resulting in disorder of the turns of the conductor wire member which form the straight portions, which will lead to air gaps among the turns. Such a phenomenon usually prominently appears in the conductor wire member made of the bundle of the wires. It is also experientially found that the above phenomenon will occur in a case where the turns of the conductor wire member are arranged in close contact with each other in the link portions.

Consequently, in the above fifth means, the winging bobbin is designed to have the distance between the portions of the paired flanges coinciding with each of the end surfaces of the cylinder which is larger than the distance between the portions of the paired flanges coinciding each of the flat surfaces of the cylinder. This type of winding bobbin is used to wind the conductor wire member several times to produce each of the winding segments, thereby facilitating reduction in space factor in the link portions to be lower than those of the straight portions. In other words, the conductor wire member is wound loosely in the link portions to reduce the transmission of the incorrect orientation or distortion of the turns of the conductor wire member in the link portions to the straight portions leading to the link portions. To say it in a different way, the conductor wire member may be wound to have a decreased size of air gaps among the turns in the straight portions to enhance the space factor in the straight portions. Conversely, the link portions have an increased size of air gaps among the turns of the conductor wire member, thereby enhancing the cooling of the link portions using air or water.

The sixth means is to provide the production method in the fifth means wherein each of the end surfaces of the cylinder is shaped in the form of a curve extending from an end of a first one of the flat surfaces to an end of a second one of the flat surfaces.

The above configuration results in an increased radius of curvature of the link portions which is larger than that in the case where the link portions are only partially curved or bent, which minimizes the transmission of the incorrect orientation or deformation of the turns of the conductor wire member from the link portions to the straight portions and enables the conductor wire member to be wound tightly to have increased numbers of columns and layers of turns in the straight portions.

The seventh means is to provide the production method in the fifth or sixth means wherein each of the flanges has tapered surfaces formed on portions thereof which coincide with one of the end surfaces of the cylinder. Each of the tapered surfaces is shaped to have an interval between the flanges which decreases toward the cylinder.

Consequently, when the conductor wire member is looped and moved from each of the flanges to an end portion of the cylinder closest to the flange, the tapered surfaces function to facilitate smooth winding of the conductor wire member around the cylinder of the winding bobbin.

The eight means is to provide the production method in any one of the fifth to seventh means wherein the winding segment making process includes a pressing process which works to compress portions of turns of the conductor wire member arranged on the flat surfaces of the cylinder using flat press members in a direction perpendicular to the flat surfaces of the cylinder after the conductor wire member is wound multiple times around the winding bobbin.

The pressing process serves to decrease the size of air gaps among the turns of the conductor wire member in the straight portions of each winding segment, thus resulting in an increase in space factor in the straight portions.

The ninth means is to provide the production method in any one of the fifth to eighth means wherein each of the conductor wire member is shaped to have a rectangular cross section, and the winding segment making process works to arrange turns of the conductor wire member adjacent to each other in multiple columns and layers and place the turn to have sides thereof in contact with each other on the flat surfaces of the cylinder.

The ninth means serves to decrease the size of air gaps among the turns of the conductor wire member in the straight portions of each winding segment, thereby resulting in an increase in space factor in the straight portions.

### BRIEF DESCRIPTION OF THE DRAWINGS

The above-described object, and other objects, features, or beneficial advantages in this disclosure will be apparent from the appended drawings or the following detailed discussion.

In the drawings:

FIG. 1 is a perspective view which illustrates a whole structure of a rotating electrical machine according to the first embodiment;

FIG. 2 is a plan view of a rotating electrical machine;

FIG. 3 is a longitudinal sectional view of a rotating electrical machine;

FIG. 4 is a transverse sectional view of a rotating electrical machine;

FIG. 5 is an exploded view of a rotating electrical machine;

FIG. 6 is a sectional view of a rotor;

FIG. 7 is a partial transverse sectional view of a sectional structure of a magnet unit;

FIG. 8 is a view which represents a relation between an electrical angle and a density of magnetic flux in magnets according to an embodiment;

FIG. 9 is a view which represents a relation between an electrical angle and a density of magnetic flux in magnets in a comparative example;

FIG. 10 is a perspective view of a stator unit;

FIG. 11 is a longitudinal sectional view of a stator unit;

FIG. 12 is a perspective illustration of a core assembly, as viewed in a first axial direction;

FIG. 13 is a perspective illustration of a core assembly, viewed from a second axial direction;

FIG. 14 is a transverse sectional view of a core assembly;

FIG. 15 is an exploded view of a core assembly;

FIG. 16 is a circuit diagram which shows connections of winding segments of a three-phase winding;

FIG. 17 is a side view which illustrates a first coil module and a second coil module arranged adjacent the first coil module for the sake of ease of comparison;

FIG. 18 is a side view which illustrates a first winding segment and a second winding segment shown to be arranged adjacent the first winding segment for the sake of ease of comparison;

FIGS. 19(a) and 19(b) are views which illustrate a structure of a first coil module;

FIG. 20 is a sectional view taken along the line 20-20 in FIG. 19(a);

FIGS. 21(a) and 21(b) are perspective views which illustrate a structure of an insulating cover;

FIGS. 22(a) and 22(b) are views which illustrate a structure of a second coil module;

FIG. 23 is a sectional view taken along the line 23-23 in FIG. 22(a);

FIGS. 24(a) and 24(b) are perspective views which illustrate a structure of an insulating cover;

FIG. 25 is a view which illustrates an overlap of film members in a circumferential array of coil modules;

FIG. 26 is a plan view which illustrates attachment of a first coil module to a core assembly;

FIG. 27 is a plan view which illustrates attachment of a first coil module and a second coil module to a core assembly;

FIGS. 28(a) and 28(b) are longitudinal sectional views which illustrate a fastened state using fastening pins;

FIG. 29 is a perspective view of a bus module;

FIG. 30 is a partial longitudinal sectional view of a bus module;

FIG. 31 is a perspective view which shows a bus module attached to a stator holder;

FIG. 32 is a longitudinal view which illustrates a fastening portion for fastening a bus module;

FIG. 33 is a longitudinal sectional view which illustrates a lead member mounted on a housing cover;

FIG. 34 is a perspective view of a lead member;

FIG. 35 is an electrical circuit diagram which illustrates a control system for a rotating electrical machine;

FIG. 36 is a functional block diagram which shows a current feedback control operation of a control device;

FIG. 37 is a functional block diagram which shows a torque feedback control operation of a control device;

FIG. 38 is a partial transverse sectional view which illustrates a modified form of a magnet unit;

FIGS. 39(a) and 39(b) are views which illustrate a structure of an inner-rotor stator unit;

FIG. 40 is a plan view which illustrates a coil module attached to a core assembly;

FIG. 41 is a perspective view which illustrates a winding segment in the second modification;

FIG. 42 is a front view which illustrates a winding segment in the second modification;

FIG. 43(a) is a cross-sectional view taken along the line I-I in FIG. 42.

FIG. 43(b) is a diagrammatic sectional view which schematically illustrates outlines of conductor segments shown in FIG. 43(a);

FIG. 44(a) is a cross-sectional view taken along the line II-II in FIG. 42.

FIG. 44(b) is a diagrammatic sectional view which schematically illustrates outlines of conductor segments shown in FIG. 44(a).

FIG. 45 is a sectional view which illustrates an intermediate conductor portion in a comparative example;

FIG. 46 is a flowchart of a sequence of steps of a production method of a stator winding;

FIG. 47(a) is a plan view which illustrates a winding bobbin;

FIG. 47(b) is a side view which illustrates a winding bobbin;

FIG. 48(a) is a side view which illustrates a winding of a conductor wire member around a winding bobbin;

FIG. 48(b) is a plan view which schematically illustrates press members;

FIG. 49(a) is a plan view which illustrates a winding bobbin in a comparative example; and

FIG. 49(b) is a side view of a winding bobbin in a comparative example.

### EMBODIMENTS FOR CARRYING OUT THE INVENTION

The embodiments will be described below with reference to the drawings. Parts of the embodiments functionally or structurally corresponding to each other or associated with each other will be denoted by the same reference numbers or by reference numbers which are different in the hundreds place from each other. The corresponding or associated parts may refer to the explanation in the other embodiments.

The rotating electrical machine in the embodiments is configured to be used, for example, as a power source for vehicles. The rotating electrical machine may, however, be used widely for industrial, automotive, domestic, office automation, or gaming applications. In the following embodiments, the same or equivalent parts will be denoted by the same reference numbers in the drawings, and explanation thereof in detail will be omitted.

### First Embodiment

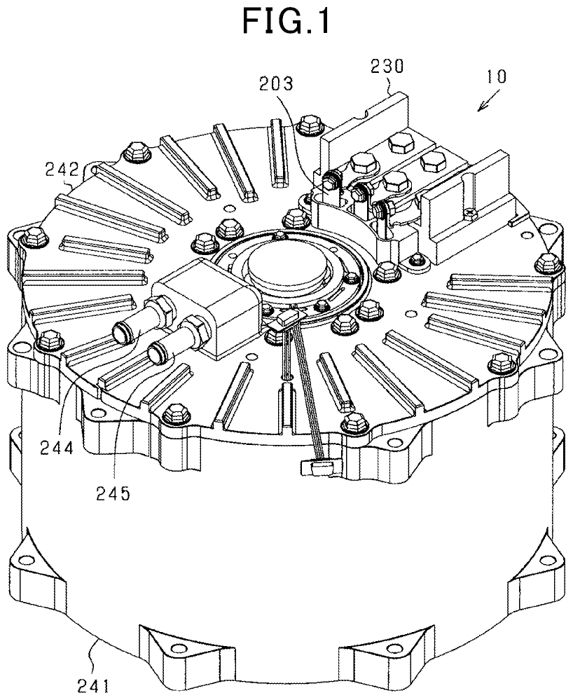

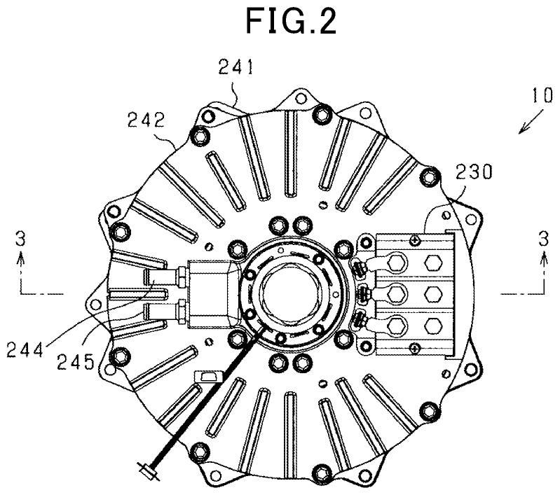

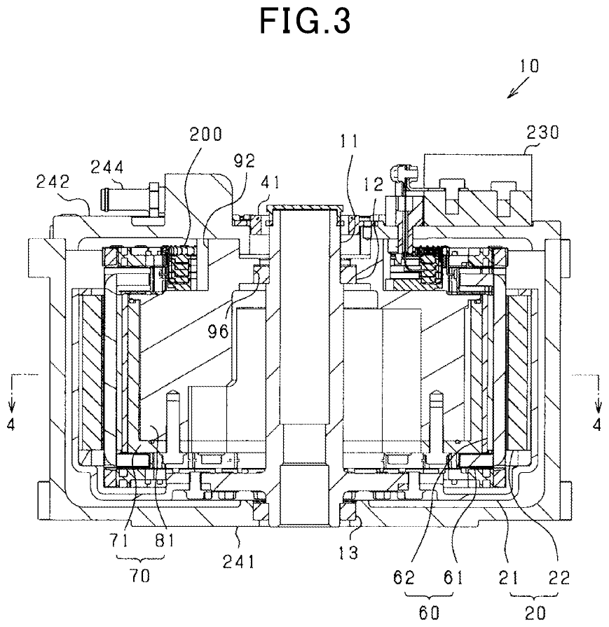

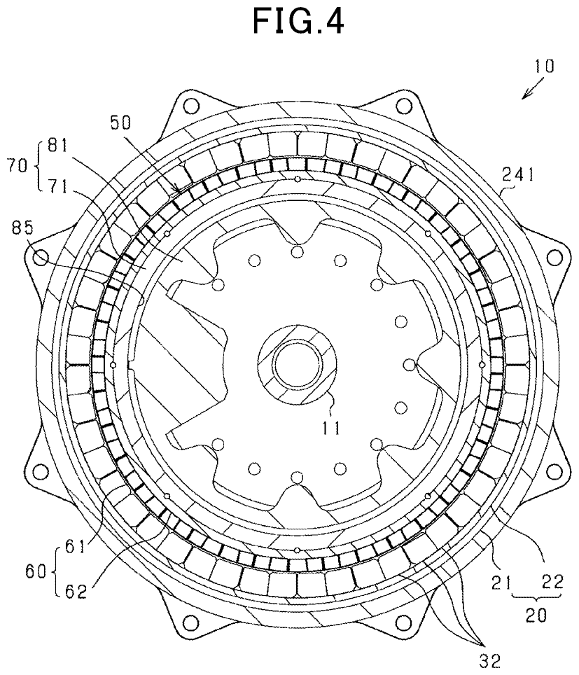

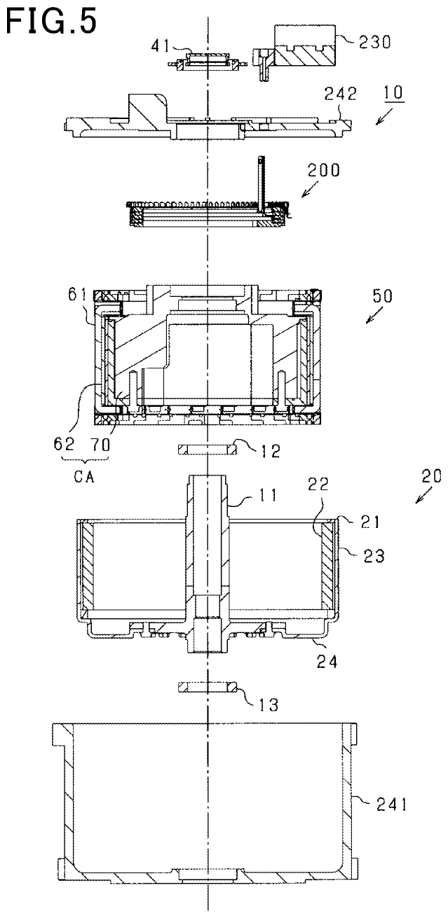

The rotating electrical machine 10 in this embodiment is a synchronous polyphase ac motor having an outer rotor structure (i.e., an outer rotating structure). The outline of the rotating electrical machine 10 is illustrated in FIGS. 1 to 5. FIG. 1 is a perspective longitudinal sectional view of the rotating electrical machine 10. FIG. 2 is a plan view of the rotating electrical machine 10. FIG. 3 is a longitudinal sectional view (i.e., sectional view taken along the line III-III in FIG. 2) of the rotating electrical machine 10. FIG. 4 is a transverse sectional view (i.e., sectional view taken along the line IV-IV in FIG. 3) of the rotating electrical machine 10. FIG. 5 is an exploded view of component parts of the rotating electrical machine 10. In the following discussion, a direction in which the rotating shaft 11 of the rotating electrical machine 10 extends will be referred to as an axial direction. A direction extending radially from the center of the rotating shaft 11 will be referred to as a radial direction. A direction extending circumferentially about the center of the rotating shaft 11 thereof will be simply referred to as a circumferential direction.

The rotating electrical machine 10 generally includes a rotating electrical machine main body equipped with the rotor 20, the stator unit 50, and the busbar module 200, the housing 241 surrounding the rotating electrical machine main body, and the housing cover 242. These parts are placed coaxially with the rotating shaft 11 secured to the rotor 20 and fabricated in a given sequence of steps in alignment with the axial direction, thereby completing the rotating electrical machine 10. The rotating shaft 11 is retained by the bearings 12 and 13 installed in the stator unit 50 and the housing 241 to be rotatable. Each of the bearings 12 and 13 is implemented by, for example, a radial ball bearing equipped with an inner race, an outer race, and balls retained between the inner race and the outer race. The rotation of the rotating shaft 11 causes, for example, an axle of a vehicle to be rotated. The installation of the rotating electrical machine 10 in the vehicle may be achieved by securing the housing 241 to a frame of a body of the vehicle.

In the rotating electrical machine 10, the stator unit 50 is disposed to surround the rotating shaft 11. The rotor 20 is disposed radially outside the stator unit 50. The stator unit 50 includes the stator 60 and the stator holder 70 assembled to a radially inner periphery of the stator 60. The rotor 20 and the stator 60 are arranged to radially face each other with an air gap therebetween. Rotation of the rotor 20 radially outside the stator 60 causes the rotating shaft 11 to rotate together with the rotor 20. The rotor 20 works as a field generator (i.e., a magnetic field-producing unit). The stator 60 works as an armature.

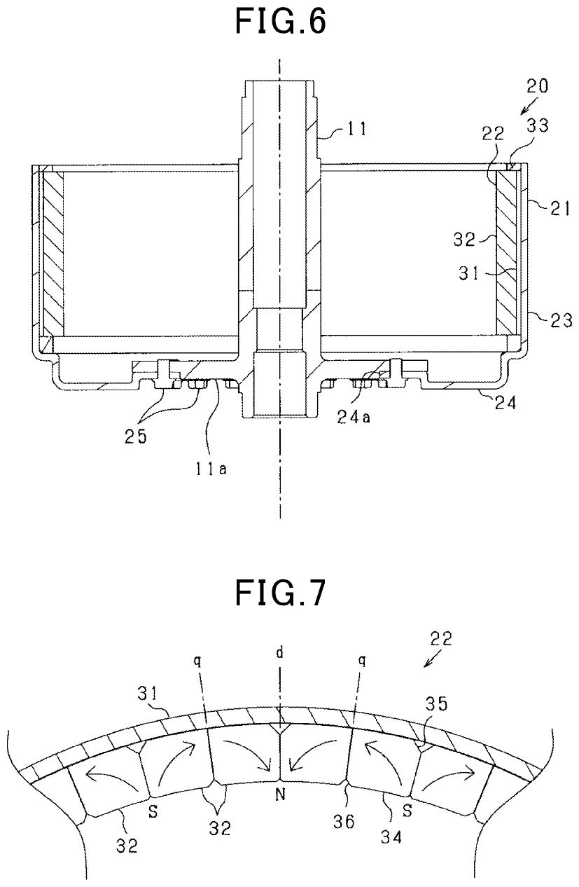

FIG. 6 is a longitudinal sectional view of the rotor 20. The rotor 20, as illustrated in FIG. 6, includes the substantially hollow cylindrical rotor carrier 21, and the annular magnet unit 22 secured to the rotor carrier 21. The rotor carrier 21 is comprised of the hollow cylindrical portion 23 and the end plate 24. The cylindrical portion 23 has opposing first and second ends in the axial direction, and the end plate 24 is mounted to the first end of the cylindrical portion 23, so that the cylindrical portion 23 and end plate 24 are integrally assembled to each other to thereby constitute the rotor carrier 21. The rotor carrier 21 serves as a magnet holder. The magnet unit 22 is mounted to a radially inner periphery of the cylindrical portion 23 in an arc-shape. The end plate 24 has the through hole 24a formed therethrough. The rotating shaft 11 passes through the through hole 24a and is retained by the end plate 24 with fasteners 25, such as bolts. The rotating shaft 11 has the flange 11a extending therefrom in a direction traversing or perpendicular to the axial direction of the rotating shaft 11. The flange 11a has an outer surface joined to an inner surface of the end plate 24, so that the rotating shaft 11 is secured to the rotor carrier 21.

The magnet unit 22 includes the cylindrical magnet holder 31, a plurality of magnets 32 secured to an inner peripheral surface of the magnet holder 31, and the end plate 33. The end plate 33 is secured to the second end of the rotor carrier 21 which is opposed to the first end of the rotor carrier 21 on which the end plate 24 is disposed. The magnet holder 31 has the same dimension as that of the magnets 32 in the axial direction. The magnets 32 are enclosed by the magnet holder 31 from radially outside it. The magnet holder 31 and the magnets 32 have axial ends firmly arranged in contact with the end plate 33.

FIG. 7 is a partially transverse sectional view of a cross-sectional structure of the magnet unit 22. Easy axes of magnetization of the magnets 32 are illustrated by arrows in FIG. 7.

The magnets 32 are disposed in the magnet unit 22 to have different magnetic poles arranged alternately in a circumferential direction of the rotor 20. This results in the magnet unit 22 having a plurality of magnetic poles arranged in the circumferential direction of the rotor 20. Each magnet 32 is made of an anisotropic permanent sintered neodymium magnet whose intrinsic coercive force is 400 [kA/m] or more and whose remanent flux density is 1.0 [T] or more.

Each of the magnets 32 has a radially inner circumferential surface serving as the magnetic flux acting surface 34 into or from which magnetic flux flows. Each of the magnets 32 have easy axes of magnetization which are different in orientation from each other between regions close to the d-axis and the q-axis. Specifically, the easy axis of magnetization in the region close to the d-axis is oriented substantially parallel to the d-axis, while the easy axis of magnetization in the region close to the q-axis is oriented substantially perpendicular to the q-axis. Such orientations define an arc-shaped magnet-produced magnetic path extending along the easy axes of magnetization. In other words, each of the magnets 32 is magnetically oriented to have the easy axis of magnetization which extends more parallel to the d-axis in the region close to the d-axis that is the center of a magnetic pole than that in the region close to the q-axis that is a magnetic boundary between the N-pole and the S-pole.

The arc-shape of the magnetic paths in the magnets 32 causes each magnetic path to have a length longer than a radial dimension or thickness of the magnet 32, thereby enhancing the permeance in the magnets 32. This enables the magnets 32 to have substantially the same capability as that of magnets whose volume is larger than the magnets 32.

A respective circumferentially adjacent two of the magnets 32 constitute a magnet pair exhibiting one magnetic pole. In other words, each of the magnets 32 circumferentially arranged in the magnet unit 22 is shaped to have division surfaces coinciding with the d-axis and the q-axis. The magnets 32 are arranged in direct contact with or close to each other. The magnets 32, as described above, have the arc-shaped magnetic paths. A respective two of the magnets 32 which are arranged circumferentially adjacent each other across the q-axis have the N-pole and the S-pole facing each other. This results in an enhanced permeance near the q-axis. The magnets 32 which are arranged on opposite sides of the q-axis attract each other, thereby ensuring the stability in contact of the magnets 32 with each other, which also enhances the permeance.

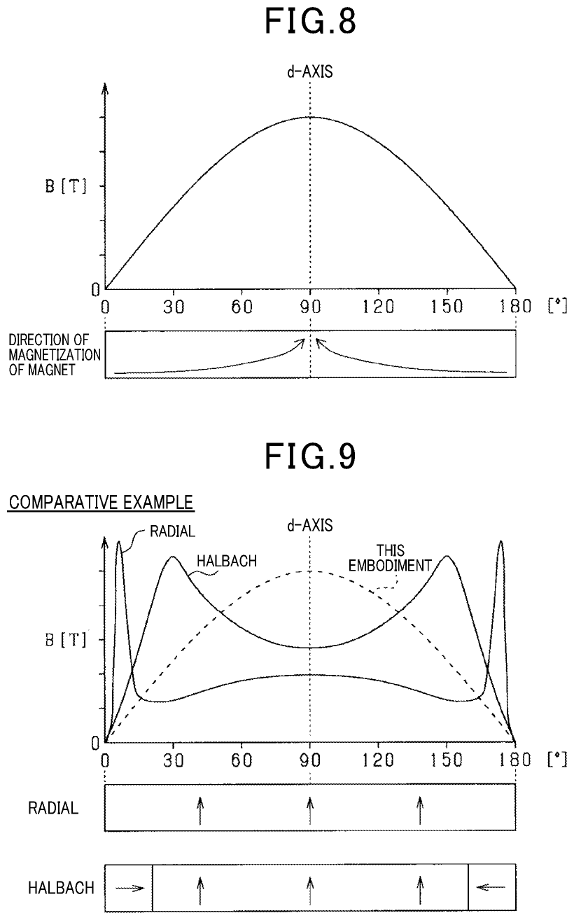

In the magnet unit 22, a magnetic flux flows in an annular shape between a respective adjacent two of the N-poles and the S-poles of the magnets 32, so that each of the magnetic paths has an increased length, as compared with, for example, radial anisotropic magnets. A distribution of the magnetic flux density will, therefore, exhibit a shape similar to a sine wave illustrated in FIG. 8. This facilitates concentration of magnetic flux around the center of the magnetic pole unlike a distribution of magnetic flux density of a radial anisotropic magnet demonstrated in FIG. 9 as a comparative example, thereby enabling the degree of torque produced by the rotating electrical machine 10 to be increased. It has also been found that the magnet unit 22 in this embodiment has the distribution of the magnetic flux density distinct from that of a typical Halbach array magnet. In FIGS. 8 and 9, a horizontal axis indicates the electrical angle, while a vertical axis indicates the magnetic flux density. 90° on the horizontal axis represents the d-axis (i.e., the center of the magnetic pole). 0° and 180° on the horizontal axis represent the q-axis.

Accordingly, the above-described structure of each of the magnets 32 functions to enhance the magnet magnetic flux thereof on the d-axis and reduce a change in magnetic flux near the q-axis. This enables the magnets 32 to be produced which have a smooth change in surface magnetic flux from the q-axis to the d-axis on each magnetic pole.

The sine wave matching percentage in the distribution of the magnetic flux density is preferably set to, for example, 40% or more. This improves the amount of magnetic flux around the center of a waveform of the distribution of the magnetic flux density as compared with a radially oriented magnet or a parallel oriented magnet in which the sine wave matching percentage is approximately 30%. By setting the sine wave matching percentage to be 60% or more, the amount of magnetic flux around the center of the waveform is improved, as compared with a concentrated magnetic flux array, such as the Halbach array.

In the radial anisotropic magnet demonstrated in FIG. 9, the magnetic flux density changes sharply near the q-axis. The sharper the change in magnetic flux density, the more an eddy current generated in the stator winding 61 of the stator 60 will increase. The magnetic flux close to the stator winding 61 also sharply changes. In contrast, the distribution of the magnetic flux density in this embodiment has a waveform approximating a sine wave. A change in magnetic flux density near the q-axis is, therefore, smaller than that in the radial anisotropic magnet near the q-axis. This minimizes the generation of the eddy current.

Adjacent corners of the radially outer surfaces of the magnets 32 are each cut to form the recess 35 in a region including the corresponding d-axis. Each of the magnets 32 has the recess 36 which is formed in the radially inner surface thereof and occupies a region including the corresponding q-axis. The directions of the above easy axes of magnetization of the magnet 32 cause magnetic paths located close to each d-axis and the radially outer surface to be shorter. Similarly, the directions of the above easy axes of magnetization of the magnet 32 cause magnetic paths located close to the q-axis and the radially inner surface to be shorter. Each magnet 32 is, therefore, configured such that some portions, which have weaker magnetic fluxes due to the shorter magnetic paths, have been already eliminated, because each of the eliminated portions have difficulty in creating a sufficient amount of magnetic flux.

The magnet unit 22 may be designed to have as many magnets 32 as the magnetic poles. For instance, each of the magnets 32 may be shaped to have a size occupying a respective circumferentially adjacent two magnetic poles between the adjacent d-axes each of which lies at the center of the magnetic pole. In this case, the center of the circumference of each of the magnets 32 coincides with the q-axis. Each of the magnets 32 has the division surfaces each coinciding with the d-axis. Each of the magnets 32 may alternatively be shaped to have a circumference whose center lies on the d-axis, not the q-axis. Instead of twice as many magnets 32 or as many magnets 32 as the magnetic poles, a circular continuous magnet may be used.

The rotating shaft 11 has opposing first and second ends in its axial direction; the first end of the rotating shaft 11 is joined to the rotor carrier 21, which is the lower end of the rotating shaft 11 in FIG. 3. The resolver 41 is mounted on the second end of the rotating shaft 11, which is the upper end of the rotating shaft 11 in FIG. 3. The resolver 41 serves as a rotation sensor. The resolver 41 includes a resolver rotor secured to the rotating shaft 11, and a resolver stator disposed radially outside the resolver rotor to face the resolver rotor. The resolver rotor has an annular disc shape, and is coaxially mounted around the rotating shaft 11. The resolver stator includes a stator core and a stator coil, and is retained to the housing cover 242.

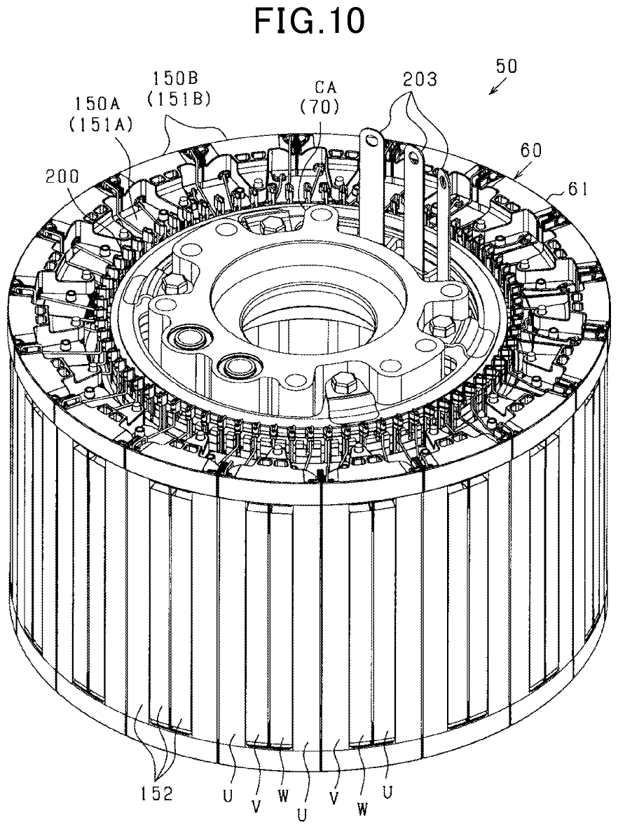

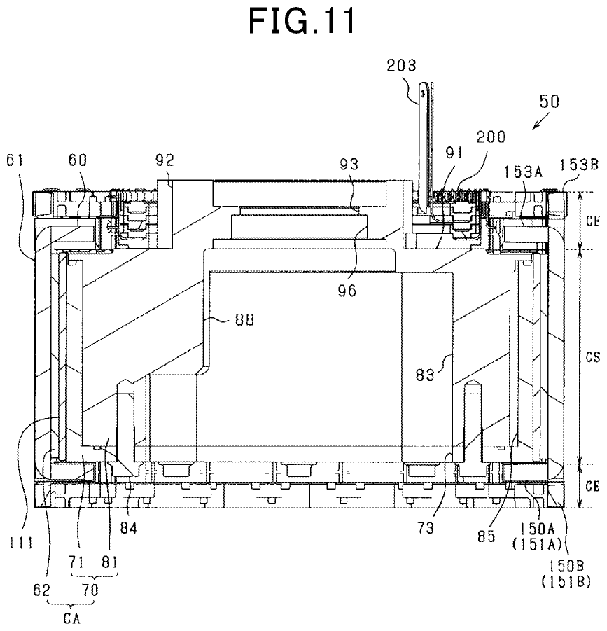

Next, the following describes the structure of the stator unit 50. FIG. 10 is a perspective view of the stator unit 50. FIG. 11 is a longitudinal sectional view of the stator unit 50 which is taken along the same line as in FIG. 3.

The stator unit 50 is schematically comprised of the stator 60 and the stator holder 70 disposed radially inside the stator 60. The stator 60 includes the stator winding 61 and the stator core 62. The stator core 62 and the stator holder 70 are integrally assembled to each other as a core assembly CA. The stator winding 61 is made up of a plurality of winding segments 151 which are disposed in the core assembly CA. The stator winding 61 serves as an armature winding. The stator core 62 serves as an armature core. The stator holder 70 serves as an armature holder. The core assembly CA serves as a retainer.

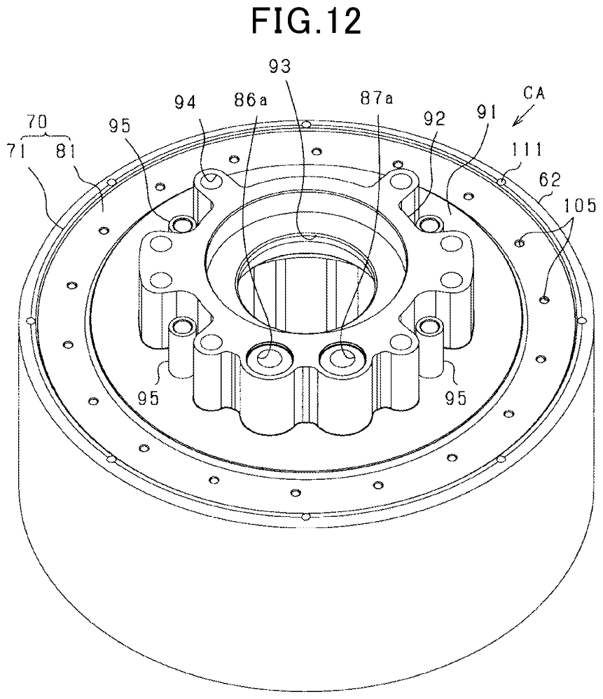

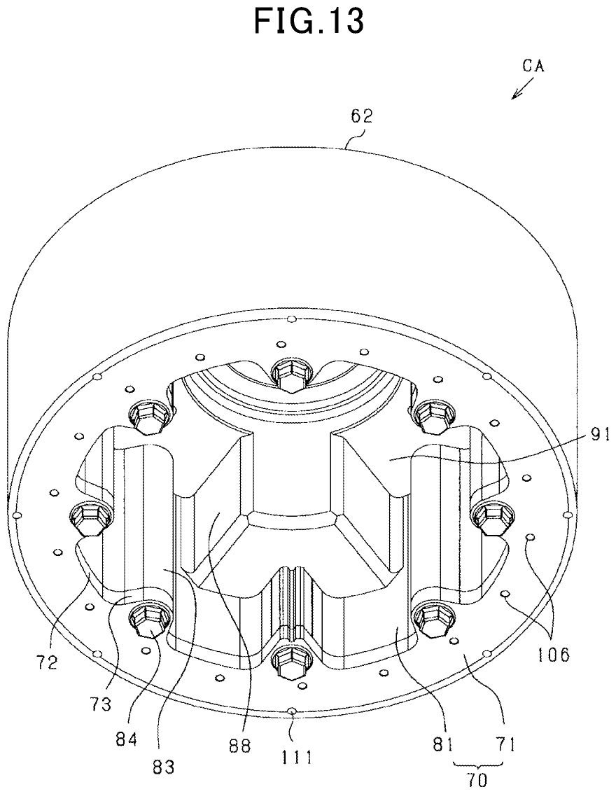

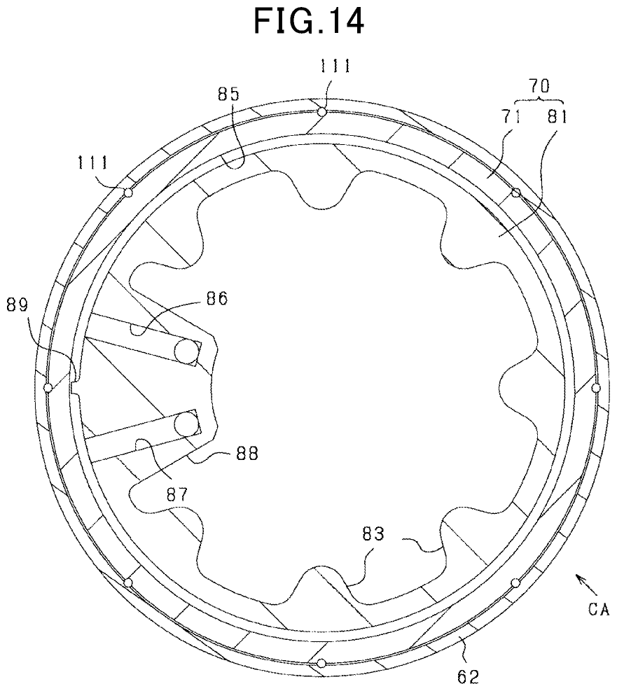

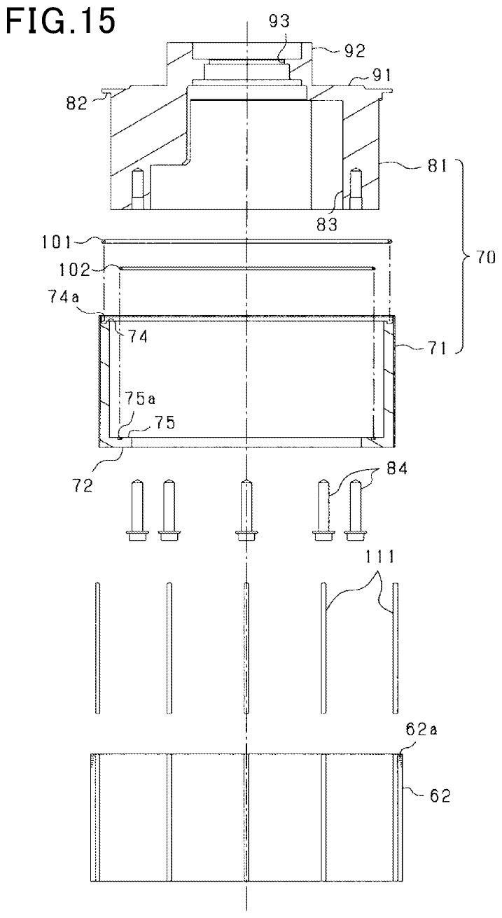

First, the following describes the core assembly CA. FIG. 12 is a perspective view of the core assembly CA, as viewed from one side of the axial direction. FIG. 13 is a perspective view of the core assembly CA, as viewed from the other side of the axial direction. FIG. 14 is a transverse sectional view of the core assembly CA. FIG. 15 is an exploded sectional view of the core assembly CA.

The core assembly CA is comprised of, as described above, the stator core 62 and the stator holder 70 assembled to the radially inner periphery of the stator core 61. In other words, the stator core 62 is integrally assembled to the outer peripheral surface of the stator holder 70.

The stator core 62 is, for example, comprised of a plurality of core sheets 62a, each of which is made of a magnetic steel plate, stacked in the axial direction in the shape of a hollow cylinder having a given thickness in the radial direction. The stator winding 61 is mounted on the outer peripheral surface of the stator core 62 which faces the rotor 20. The stator core 62 has no irregularities on the outer peripheral surface thereof. The stator core 62 functions as a back yoke. The stator core 62 is, for example, comprised of the plurality of core sheets 62a stacked in the axial direction; each core sheet 62a has been punched out to have an annular plate-like shape. For the stator core 62 having a helical configuration, the stator core 62 may be comprised of elongated sheets helically wound and stacked in the axial direction to be shaped overall as a hollow cylindrical shape.

The stator 60 is designed to have a slot-less structure with no teeth for defining slots. Specifically, the stator 60 has any of the following structures:

(A) The stator 60 has inter-conductor members, each of which is disposed between conductor portions (intermediate conductor portions 152 described later) in the circumferential direction. As the inter-conductor members, magnetic material is used which meets a relation of Wt×Bss≤Wm×Br where Wt is a width of the inter-conductor members in the circumferential direction within one magnetic pole, Bs is the saturation magnetic flux density of the inter-conductor members, Wm is a width of the magnets 32 equivalent to one magnetic pole in the circumferential direction, and Br is the remanent flux density in the magnet 32.
(B) The stator 60 has the inter-conductor members each of which is disposed between the conductor portions (intermediate portions 152) in the circumferential direction. The inter-conductor members are each made of a non-magnetic material.
(C) The stator 60 has no inter-conductor member disposed between the conductor portions (i.e., the intermediate portions 152) in the circumferential direction.

The stator holder 70 is, as illustrated in FIG. 15, comprised of an outer cylindrical member 71 and an inner cylindrical member 81. The outer and inner cylindrical members 71 and 81 are integrally assembled to each other while the inner cylindrical member 81 is disposed radially inside the outer cylindrical member 71, in other words, the outer cylindrical member 71 is disposed radially outside the inner cylindrical member 81. Each of the outer and inner cylindrical members 71 and 81 is made of, for example, metal, such as aluminum or cast iron, or carbon fiber reinforced plastic (CFRP).

The outer cylindrical member 71 has a hollow cylindrical shape with the curvature of each of the outer and inner peripheral surfaces thereof being an exact circle. The outer cylindrical flange 72 has opposing first and second ends in its axial direction, and has the annular flange 72 extending radially inward from the first end thereof. The flange 72 has protrusions 73 arranged at a regular interval away from each other in the circumferential direction thereof (see FIG. 13). The outer cylindrical member 71 has the axially facing surfaces 74 and 75 which lie at the first and second ends thereof axially opposed to each other and face the inner cylindrical member 81 in the axial direction. The axially facing surfaces 74 and 75 have annular grooves 74a and 75a formed therein.

The inner cylindrical member 81 has an outer diameter smaller than that of the outer cylindrical member 71. The inner cylindrical member 81 has a hollow cylindrical shape with the curvature of the outer peripheral surface thereof being an exact circle. The inner cylindrical member 81 has opposing first and second ends in its axial direction, and has the annular outer flange 82 extending radially outward from the second end thereof. The inner cylindrical member 81 is assembled to the outer cylindrical member 71 while being in contact with the axially facing surfaces 74 and 75 of the outer cylindrical member 71. As illustrated in FIG. 13, the inner and outer cylindrical members 71 and 81 are fastened to each other using fasteners 84, such as bolts. Specifically, the inner cylindrical member 81 has a plurality of protrusions 83 formed on an inner peripheral surface thereof. The protrusions 83 are arranged at a regular interval away from each other in the circumferential direction of the inner cylindrical member 81 and protrude radially inward. The protrusions 83 have axially end surfaces placed laid to overlap the protrusions 73 of the outer cylindrical member 71. The protrusions 73 and 83 are joined together using the fasteners 84.

The outer and inner cylindrical members 71 and 81 are, as illustrated in FIG. 14, integrally assembled to each other. The inner peripheral surface of the outer cylindrical member 71 and the outer peripheral surface of the inner cylindrical member 81 are disposed to face each other with an annular clearance therebetween; the annular clearance serves as a coolant path 85 through which coolant, such as water, is supplied to flow. The coolant path 85 is formed to have an annular shape in the circumferential direction of the stator holder 70. More specifically, the inner cylindrical member 81 has the path formation wall 88 protruding from the inner peripheral surface of the inner cylindrical member 81; the path formation wall 88 has formed therein the inlet path 86 and the outlet path 87. Each of the paths 86 and 87 opens at the outer peripheral surface of the inner cylindrical member 81. The inner cylindrical member 81 has the partition 89 formed on the outer peripheral surface thereof to divide the coolant path 85 into an input side and an output side. This enables a coolant entering the input path through the inlet path 86 to flow the coolant path 85 in the circumferential direction, and thereafter to flow out from the outlet path 87.

Each of the inlet path 86 and the outlet path 87 has opposing first and second ends in its length direction. The first end of each of the inlet path 86 and outlet path 87 radially extends and opens at the outer peripheral surface of the inner cylindrical member 81. The second end of each of the inlet path 86 and the outlet path 87 axially extends and opens at an axial end of the inner cylindrical member 81. FIG. 12 shows the inlet opening 86a communicating with the inlet path 86 and the outlet opening 87a communicating with the outlet path 87. The inlet path 86 and the outlet path 87 communicate with the inlet port 244 and the outlet port 245 of the housing cover 242 (see FIG. 1), so that the coolant flows into the inlet port 244 and out of the outlet port 245.

The seal member 101 is disposed between the second end of the outer cylindrical member 71 and the second end of the inner cylindrical member 81 that is joined to the second end of the outer cylindrical member 71. The seal member 102 is disposed between the first end of the outer cylindrical member 71 and the first end of the inner cylindrical member 81 that is joined to the first end of the outer cylindrical member 71 (see FIG. 15). Specifically, the seal member 101, which is, for example, an O-ring, is disposed in the annular groove 74a of the outer cylindrical member 71 while being compressed by the inner cylindrical member 81. Similarly, the seal member 102, which is, for example, an O-ring, is disposed in the annular groove 75a of the outer cylindrical member 71 while being compressed by the inner cylindrical member 81.

The inner cylindrical member 81 has, as illustrated in FIG. 12, the annular end plate 91 at the second end thereof. The boss 92, which has a hollow cylindrical shape, is mounted on an outer surface of the end plate 91 to extend outwardly therefrom in the axial direction. The boss 92 extends around the through hole 93 through which the rotating shaft 11 passes. The boss 92 has a plurality of fasteners 94 for use in securement of the housing cover 242. The end plate 91 has disposed thereon a plurality of rods 95 which are located radially outside the boss 92 and extend in the axial direction. The rods 95, as will be described later in detail, serve as retainers for use in securement of the busbar module 200. The boss 92 serves as a bearing retainer which retains the bearing 12. Specifically, the bearing 12 is firmly mounted in the bearing holder 96 formed in an inner portion of the boss 92 (see FIG. 3).

the outer cylindrical member 71 and the inner cylindrical member 81, as clearly illustrated in FIGS. 12 and 13, have the recesses 105 and 106 for use in securement of a plurality of coil modules 150 which will be described later.

Specifically, the recesses 105 are, as clearly illustrated in FIG. 12, formed in an axial end of the inner cylindrical member 81, i.e., an axial outer end of the end plate 91 around the boss 92. The recesses 105 are arranged at equal intervals away from each other in the circumferential direction of the end plate 91. The recesses 106 are, as clearly illustrated in FIG. 13, formed in an axial end of the outer cylindrical member 71, i.e., an axial outer end of the flange 72. The recesses 106 are arranged at equal intervals away from each other in the circumferential direction of the flange 72. The recesses 105 and 106 are arranged on an imaginary circle defined to be coaxial with the core assembly CA. The recesses 105 are aligned with the recesses 106 in the axial direction. The recesses 105 and 106 are identical in number and spacing therebetween with each other.

The stator holder 70 is assembled to the stator core 62 while the stator core 62 applies radial compression force to the stator holder 70 for ensuring sufficient force to assemble the stator holder 70 and the stator core 62 to each other. Specifically, the stator holder 70 is fixedly fit in the stator core 62 using shrinkage-fitting or press-fitting with a predetermined degree of interference therebetween. This results in the stator core 62 and the stator holder 70 being assembled to each other while one of the stator core 62 and the stator holder 70 applies radial stress to the other thereof. For obtaining a high degree of torque from the rotating electrical machine 10, let us consider a measure to, for example, make the size of the stator 60 larger, resulting in a larger degree of force of the stator core 62, which tightens the stator holder 70 to the stator core 62, in order to firmly join the stator core 62 to the stator holder 70 together. An increase in compressed stress of the stator core 62, in other words, residual stress of the stator core 62, may result in a risk of causing the stator core 62 to be broken down.

In light of the above drawback, the structure in this embodiment in which the stator holder 79 is fit in the stator core 62 with a given amount of interference therebetween is designed to have a stopper which is arranged in portions of the stator core 62 and the stator holder 70 which radially face each other and works to achieve engagement of the stator core 62 and the stator holder 70 to hold the stator core 62 from moving in the circumferential direction thereof. Specifically, a plurality of engagement members 111 are, as illustrated in FIGS. 12 to 14, disposed between the stator core 62 and the outer cylindrical member 71 of the stator holder 70. The engagement members 111 are arranged at a given interval away from each other in the circumferential direction and function as stoppers to control misalignment between the stator core 62 and the stator holder 70 in the circumferential direction. For instance, one of the stator core 62 and the outer cylindrical member 71 may have formed therein recesses in which the engagement members 111 are fit. Instead of the engagement members 111, one of the stator core 62 and the outer cylindrical member 71 may alternatively have formed thereon protrusions fit in the recesses.

The above structure, therefore, serves to eliminate the risk of misalignment between the stator core 62 and the stator holder 70 (i.e., the outer cylindrical member 71) in the circumferential direction as well as to ensure an interference fit between the stator core 62 and the stator holder 70 (i.e., the outer cylindrical member 71). This, therefore, ensures the stability in alignment between the stator core 62 and the stator holder 70 even if the amount of interference between the stator core 62 and the stator holder 70 is relatively small and also eliminates the risk of damage to the stator core 62 which usually rises from an increase in amount of interference fit between the stator core 62 and the stator holder 70.

The inner cylindrical member 81 has an annular inner chamber formed radially thereinside around the rotating shaft 11. Electrical components, such as electrical components constitute, for example, an inverter serving as a power converter, may be installed in the annular inner chamber. The electrical components for example include one or more electrical modules in each of which semiconductor switches and capacitors are packaged. The electrical components are arranged while being in contact with the inner peripheral surface of the inner cylindrical member 81. The cooling of the electrical modules using the coolant flowing in the coolant path 85 may be achieved by arranging the electrical modules in contact with the inner periphery of the inner cylindrical member 81. The volume of the inner chamber located inside the inner periphery of the inner cylindrical member 81 may be increased by eliminating the protrusions 83 on the inner periphery of the inner cylindrical member 81 or decreasing the height of the protrusions 83.

Next, the structure of the stator winding 61 installed in the core assembly CA will be described below in detail. The stator winding 61 mounted in the core assembly CA is shown in FIGS. 10 and 11. Specifically, the winding segments 151, which constitute the stator winding 61, are circumferentially arranged radially outside the core assembly CA, i.e., the stator core 62.

The stator winding 61 is comprised of plural-phase windings that are arranged in a predetermined order in the circumferential direction; the assembly of the plural-phase windings arranged in the circumferential direction has a hollow cylindrical shape, i.e., an annular shape. The stator winding 61 in this embodiment includes three-phase windings: a U-phase winding, a V-phase winding, and a W-phase winding.

The stator 60, as illustrated in FIG. 11, includes an axial inside portion serving as the coil side CS that radially faces the magnet unit 22 of the rotor 20 and axial outside portions serving as the coil ends CE located axially outside the coil side CS. The stator core 62 is disposed inside the coil side CS such that the axial length of the stator core 62 occupies the axial length of the coil side CS.

Each-phase winding in the stator winding 61 includes a plurality of winding segments 151 (see FIG. 16), and each of the winding segments 151 constitutes the coil module 150. In other words, the coil module 150 of each phase winding is comprised of a modularized winding segment 151 of the corresponding phase winding. The stator winding 61 is made of a predetermined number of coil modules 150, which is determined based on the number of magnet poles of the rotating electrical machine. Arranging the coil modules 150 of the plural-phase windings in the predetermined order in the circumferential direction results in the conductor portions of the plural-phase windings being arranged in the predetermined order; the arranged conductor portions of the plural-phase windings constitute the coil side CS of the stator winding 61. FIG. 10 illustrates the predetermined order of arrangement of the conductor portions of the U-, V-, and W-phase windings in the coil side CS of the stator winding 61. The number of magnet poles of the rotating electrical machine is set to 24, but may be optional.

The winding segments 151 of the coil modules 150 of each phase winding are connected in parallel or series to each other to thereby constitute the corresponding phase winding. FIG. 16 illustrates electrical connections among the winding segments 151 of each of the U-, V-, and W-phase windings. In FIG. 16, the winding segments 151 of each of the U-, V-, and W-phase windings are connected in parallel to each other.

The coil modules 150 are, as illustrated in FIG. 11, attached to the radial outside of the stator core 62. The coil modules 150 are attached to the stator core 62 while both end portions of the coil modules 150 in the axial direction project outside of the stator core 62, i.e., project toward the respective coil ends CE, in the axial direction. Specifically, the stator winding 61 includes an axial inside portion serving as the coil side CS and axial outside portions serving as the coil ends CE located on the axial outside of the coil side CS.

The coil modules 150 include a first type of coil modules 150 and a second type of coil modules 150. The configuration of each coil module 150 included in the first type is different from the configuration of each coil module 150 included in the second type. The winding segment 151 of each coil module 150 included in the first type has opposing first and second ends in the axial direction of the stator core 62, and each of the first and second ends of the winding segment 151 of each coil module 150, which constitutes a corresponding one of the coil ends CE, is bent radially inside the stator core 62. In contrast, the winding segment 151 of each coil module 150 included in the second type has opposing first and second ends in the axial direction of the stator core 62, and each of the first and second ends of the winding segment 151 of each coil module 150, which constitutes a corresponding one of the coil ends CE, extends linearly in the axial direction of the stator core 62 without being bent. In the following discussion for the sake of convenience, the winding segment 151, whose first and second ends are bent radially inside the stator core 62, will be referred to as a first winding segment 151A, and the coil module 150 including the first winding segment 151A will be referred to as a first coil module 150A. Similarly, the winding segment 151, whose first and second ends extend in the axial direction of the stator core 62 without being bent, will be referred to as a second winding segment 151B, and the coil module 150 including the second winding segment 151B will be referred to as a second coil module 150B.

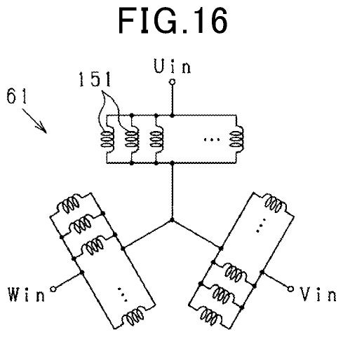

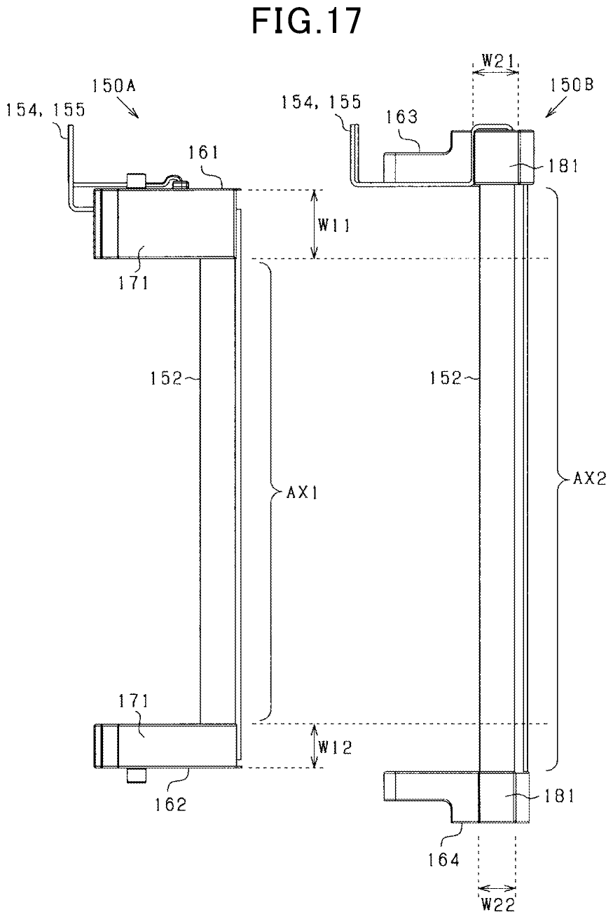

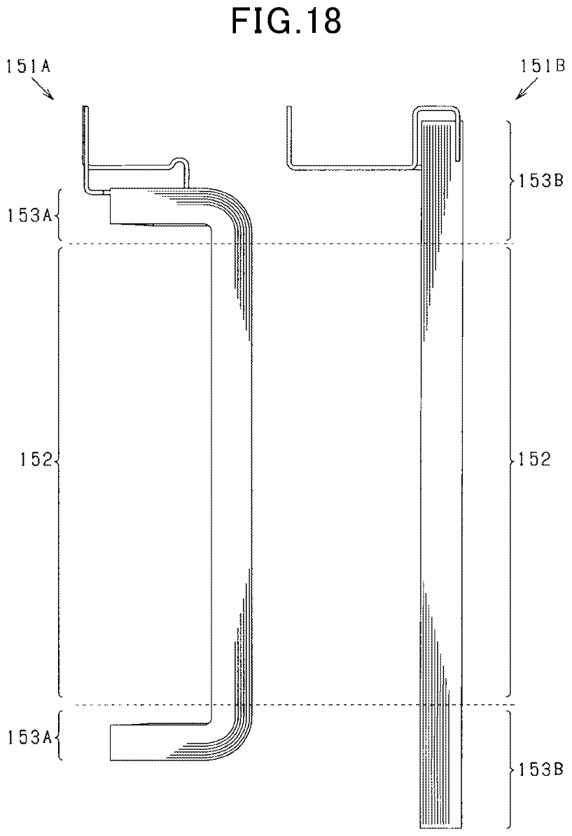

FIG. 17 is a side view of each of the first coil module 150A and second coil module 150B which are arranged side by side for ease of comparison therebetween. FIG. 18 is a side view of each of the first winding segment 151A and second winding segment 151B which are arranged side by side for ease of comparison therebetween. As illustrated in each of FIGS. 17 and 18, each of the first and second coil modules 150A and 150B has a length in the axial direction of the stator core 62, and the axial length of the first coil module 150A is different from that of the second coil module 150B. Similarly, each of the first and second winding segments 151A and 151B has a length in the axial direction of the stator core 62, and the axial length of the first winding segment 151A is different from that of the second winding segment 151B. Additionally, the shape of each of the first and second ends of the first coil module 150A is different from that of the corresponding one of the first and second ends of the second coil module 150B. Similarly, the shape of each of the first and second ends of the first winding segment 151A is different from that of the corresponding one of the first and second ends of the second winding segment 151B. The first winding segment 151A has a substantially C-shape as viewed from the side, and the second winding segment 151B has a substantially I-shape as viewed from the side. Insulating covers 161 and 162, each of which serves as a first insulating cover, are mounted on the respective first and second ends of the first winding segment 151A in the axial direction. Similarly, insulating covers 163 and 164, each of which serves as a second insulating cover, are mounted on the respective first and second ends of the second winding segment 151B in the axial direction.

The following describes the configuration of each of the coil modules 150A and 150B in detail.

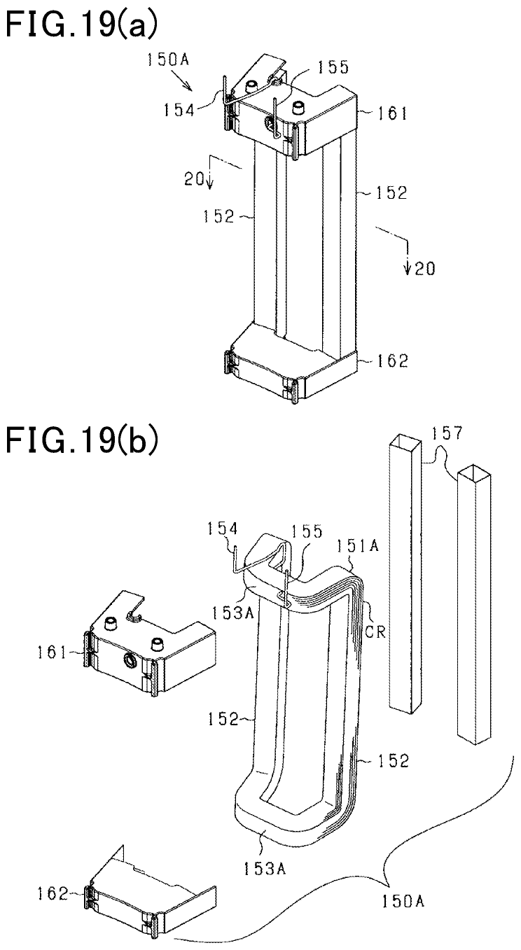

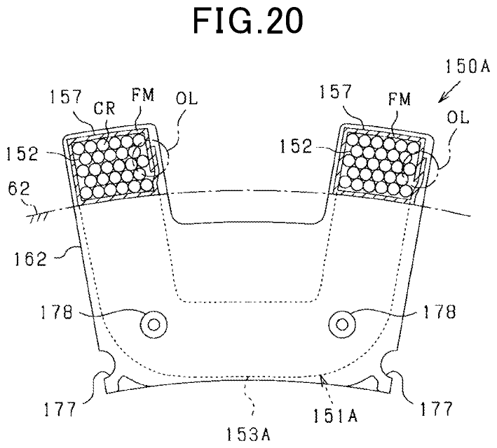

First, the following describes the configuration of the first coil module 150A. FIG. 19(a) is a perspective view of the first coil module 150A, and FIG. 19(b) is an exploded perspective view of components of the first coil module 150A. FIG. 20 is a sectional view taken along the line 20-20 in FIG. 19(a).

As illustrated in FIGS. 19(a) and 19(b), the first coil module 150A includes the first winding segment 151A, and the insulating covers 161 and 162. The winding segment 151A is comprised of a conductive wire member CR that is multiply wound. The insulating covers 161 and 162 are mounted on the respective first and second ends of the first winding segment 151A in the axial direction. Each of the insulating covers 161 and 162 is molded by an insulating material, such as a synthetic resin material.

The first winding segment 151A is comprised of a pair of intermediate conductor portions 152 and a pair of link portions 153A. The intermediate conductor portions 152 are disposed to linearly extend in parallel to each other. Each of the intermediate conductor portions 152 has opposing first and second axial ends respectively correspond to the first and second axial ends of the first winding segment 151A. One of the link portions 153A links or joints the first axial ends of the respective intermediate conductor portions 152 to each other, and the other of the link portions 153A links or joints the second axial ends of the respective intermediate conductor portions 152 to each other. The assembly of the intermediate conductor portions 152 and the link portions 153A constitutes the first winding segment 151A having an annular shape. The intermediate conductor portions 152 are arranged at a predetermined number of coil pitches away from each other. This arrangement of the intermediate conductor portions 152 of each phase winding enables at least one intermediate conductor portion 152 of at least one other-phase winding to be arranged between the intermediate conductor portions 152 of the corresponding phase winding. The intermediate conductor portions 152 of each phase winding in this embodiment are arranged two coil pitches away from each other. This arrangement of the intermediate conductor portions 152 of each phase winding enables two intermediate conductor portions 152 of the respective other phase windings to be arranged between the intermediate conductor portions 152 of the corresponding phase winding.

Each of the link portions 153A has the same shape. Each of the link portions 153A constitutes the corresponding one of the coil ends CE (see FIG. 11). Specifically, each of the link portions 153A is bent to extend perpendicularly to the intermediate conductor portions 152, i.e., to the axial direction.

Each of the first winding segments 151A, as clearly illustrated in FIG. 18, has axially opposed ends defining the link portions 153A. Each of the second winding segments 151B has axially opposed ends defining the link portions 153B. The link portions 153A and 153B of the winding segments 151A and 151B are different in configuration from each other. For ease of identification between the link portions 151A and 153B, the link portions 153A of the first winding segments 151A will also be referred to below as the first link portions 153A. The link portions 153B of the second winding segments 151B will also be referred to below as the second link portions 153B.

The intermediate conductor portions 152 of each of the winding segments 151A and 151B serve as coil side conductor portions that are circumferentially arranged away from each other and constitute the coil side CS. Each of the link portions 153A and 153B serves as a coil end link portion that links two of the intermediate conductor portions 152, which are located at different circumferential positions, of a corresponding same phase with each other; each of the link portions 153A constitutes the corresponding one of the coil ends CE.

The first winding segment 151A is, as illustrated in FIG. 20, comprised of the multiply wound conductive wire member CR to thereby have a substantially rectangular or square shape in its transverse section. FIG. 20 illustrates the transverse section of the intermediate conductor portions 152. As illustrated in FIG. 20, the conductive wire member CR is multiply wound, so that parts of the multiply-wound conductive wire member CR are arrayed in each intermediate conductor portion 152 in both the circumferential and radial directions. The arrayed parts of the multiply-wound conductive wire member CR in each intermediate conductor portion 152 of the first winding segment 151A in both the circumferential and radial directions result in the corresponding intermediate conductor portion 152 having a substantially rectangular shape. In each of the first link portions 153A, parts of the multiply wound conductive wire member CR are bent so that the bent parts of the multiply wound conductive wire member CR are arrayed in both the axial and radial directions in a radian end of the corresponding one of the first link portions 153A. In particular, the conductive wire member CR in this embodiment is concentrically wound to thereby constitute the first winding segment 151A. Howe to wound the conductive wire member CR is, however, optional. For example, the conductive wire member CR may be multiply wound in the form of an alpha winding coil.

The conductive wire member CR has both ends 154 and 155 opposite to each other. The ends 154 and 155, which will be referred to as winding ends 154 and 155, of the multiply wound conductor wire member CR are drawn out from the respective ends of one of the first link portions 153A, which is located at the second end (upper end) of the first winding segment 151A in FIG. 19(b). One of the winding ends 154 and 155 represents the start of winding of the multiply wound conductor wire member CR, and the other thereof represents the end of winding of the multiply wound conductor wire member CR. One of the winding ends 154 and 155 is connected to a current input/output (I/O) terminal, and the other of the winding ends 154 and 155 is connected to the neutral point.

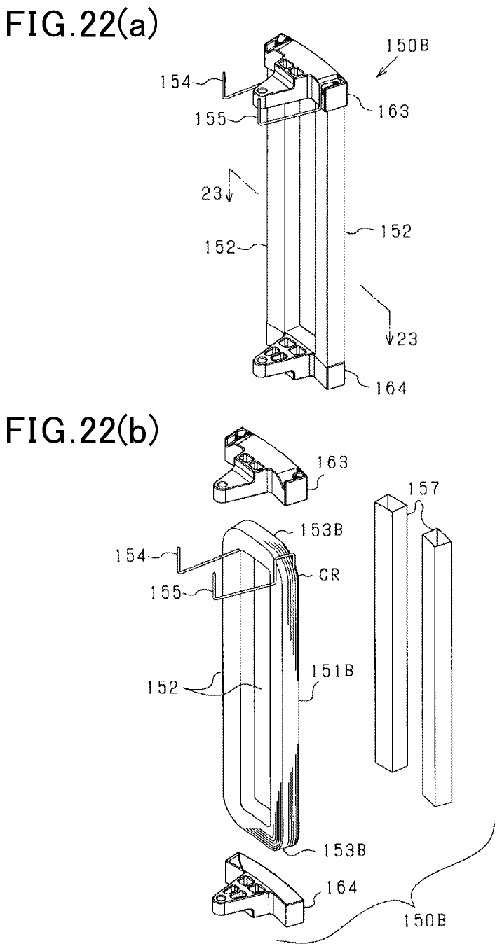

Each intermediate conductor portion 152 of the first winding segment 151A is covered with the sheet-like insulating jacket 157. FIG. 19(a) illustrates the first coil module 150A in which the intermediate conductor portions 152 are covered with the insulating jackets 157, in other words, the intermediate conductor portions 152 are disposed inside the insulating jackets 157, but however, a combination of each of the intermediate conductor portions 152 and a corresponding one of the insulating jackets 157 is denoted by numeral 152 for the sake of convenience. The same applies to FIG. 22(a), as will be referred to later.

Each of the insulating jackets 157 is made of a film member FM that has a predetermined length that corresponds to an axial length of a portion of the intermediate conductor portion 152; the portion should be covered with an insulating material. The film member FM is wrapped around the intermediate conductor portion 152. The film member FM is for example made of polyethylene naphthalate (PEN). Specifically, the film member FM is comprised of a film base having opposing first and second surfaces, and a foamable adhesion layer mounted on the first surface of the film base. The film member FM is wrapped around and attached to an outer peripheral surface of the intermediate conductor portion 152 using the adhesion layer. The adhesion layer may be made from a non-foamable adhesive.

As illustrated in FIG. 20, parts of the multiply-wound conductive wire member CR are arrayed in each intermediate conductor portion 152 in both the circumferential and radial directions. This results in each intermediate conductor portion 152 having a substantially rectangular shape in its transverse cross section. The film member FM is wrapped around the outer peripheral surface of each intermediate conductor portion 152 while both circumferential ends of the film member FM are overlapped with each other, so that the insulating jacket 157 is disposed on the intermediate conductor portion 152. The film member FM is comprised of a rectangular sheet that has a predetermined longitudinal length that is longer than a single wrap-around length of each intermediate conductor portion 152, and has a predetermined lateral length that is longer than that of the corresponding intermediate conductor portion 152. The rectangular film member FM is wrapped around the outer peripheral surface of each intermediate conductor portion 152 while being folded along respective sides of the corresponding intermediate conductor portion 152. Foam produced from the adhesion layer is filled in a clearance between the intermediate conductor portion 152 and the film member FM wrapped therearound. The adhesion layer of one of the overlapped circumferential ends of the film member FM is joined to the adhesion layer of the other of the overlapped circumferential ends of the film member FM.

More specifically, each intermediate conductor portion 152 has a pair of first and second circumferential sides opposite to each other, each of which extends in a corresponding circumferential direction of the stator core 62, and a pair of first and second radial sides opposite to each other, each of which extends in a corresponding radial direction of the stator core 62. The insulating jacket 157 is wrapped around each intermediate conductor portion 152 to cover all the sides thereof. The first circumferential side of each intermediate conductor portion 152 of one phase winding faces the first circumferential side of a circumferentially adjacent intermediate conductor portion 152 of another phase winding. The overlapped circumferential ends of the film member FM will also be referred to as an overlapped portion OL. The overlapped portion OL of the film member FM wrapped around each intermediate conductor portion 152 of one phase winding is located on the first circumferential side of the corresponding intermediate conductor portion 152 of the one phase winding. That is, in the first winding segment 151A, the overlapped portion OL of the film member FM is located on the same first circumferential side of each of the intermediate conductor portions 152.

In the first winding segment 151A, the insulating jacket 157 wrapped around each intermediate conductor portion 152 extends between a part of the lower-side link portion 153A and a part of the upper-side link portion 153A; the part of the lower-side link portion 153A is covered with the insulating cover 162 and the part of the upper-side link portion 153A is covered with the insulating cover 161. In other words, the part of the lower-side link portion 153A is located within the insulating cover 162 and the part of the upper-side link portion 153A is located within the insulating cover 161. Referring to FIG. 17, reference character AX1 represents a portion of the first coil module 150A, which is uncovered with the insulating covers 161 and 162. The insulating jacket 157 is provided to cover over an extended portion of the first coil module 150A, which is axially wider than the portion AX1 of the first coil module 150A.

Next, the following describes the structure of each of the insulating covers 161 and 162.

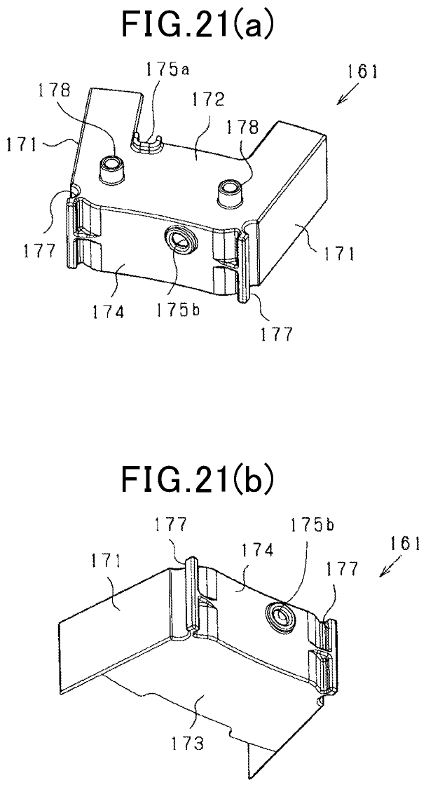

The insulating cover 161 is mounted to cover over the first link portion 153A disposed at the second end of the first winding segment 151A in the axial direction. The insulating cover 162 is mounted to cover over the first link portion 153A disposed at the first end of the first winding segment 151A in the axial direction. FIGS. 21(a) and 21(b) are perspective views respectively illustrating the insulating cover 161 as viewed from different directions.

As illustrated in FIGS. 21(a) and 21(b), the insulating cover 161 includes a pair of side walls 171, an outer wall 172, an axially inner wall 173, and a front wall 174. The side walls 171 constitute sides of the insulating cover 161 arranged at different positions in the circumferential direction of the stator core 62. The outer wall 172 constitutes an axially outer side of the insulating cover 161. The front wall 174 constitutes a radially inner side of the insulating cover 161. Each of the walls 171 to 174 has a plate-like shape, and are assembled to each other to have a solid shape with a radially outer opening surface. Each of the side walls 171 is disposed to be oriented toward the center axis of the core assembly CA to which the stator winding 61 including the side walls 171 is assembled. While the first coil modules 150A are arranged in the circumferential direction, the side walls 171 of each circumferentially adjacent pair of the insulating covers 161 face one another with being in contact with or adjacent to one another. This enables the first coil modules 150A to be arranged in the circumferential direction while being electrically isolated from each other.

The outer wall 172 of the insulating cover 161 has the opening 175a formed therethrough. The opening 175a enables the winding end 154 of the first winding segment 151A to be drawn out therethrough from the inside of the insulating cover 161. The front wall 174 of the insulating cover 161 has the opening 175b formed therethrough from the inside of the insulating cover 161. The opening 175b enables the winding end 155 of the first winding segment 151A to be drawn out therethrough from the inside of the insulating cover 161. The winding end 154 of the first winding segment 151A is drawn out through the opening 175a of the outer wall 172 in a corresponding radial direction and thereafter extends in the axial direction. The winding end 155 of the first winding segment 151A is drawn out from the inside of the insulating cover 161 through the opening 175b of the front wall 174 in the circumferential direction, and thereafter extends in a corresponding radial direction.

Each of the side walls 171 of the insulating cover 161 has the recess 177 disposed at a corner at the intersection of the corresponding one of the side walls 171 and the front wall 174. The recess 177 of each side wall 171 extends in the axial direction, and has a semi-circular shape in its transverse cross section. The insulating cover 161 has a center line along a corresponding radial direction; one side of the insulating cover 161 relative to the center line in the circumferential direction and the other side of the insulating cover 161 relative to the center line in the circumferential direction are symmetrical with each other about the center line. The outer wall 172 of the insulating cover 161 has a pair of protrusions 178 disposed at respective positions that are symmetrical with one another about the center line in the circumferential direction. Each protrusion 178 extends in the axial direction.

The following describes additional information about the recesses 177 of the insulating cover 161. As illustrated in FIG. 20, the first link portions 153A of the first winding segment 151A have a recessed shape that is convex toward the radial inside, i.e., toward the core assembly CA. This results in a circumferential space being formed between the circumferentially adjacent first link portions 153A of each circumferentially adjacent pair of first coil modules 150A; the circumferential space becomes wider as the space approaches the core assembly CA. This embodiment uses the circumferential spaces to form the recesses 177 in the side walls 171 of the insulating cover 161, that is, outside the curved portion of the first link portion 153A.

A temperature sensor, such as a thermistor, may be mounted to the first winding segment 151A. In this modification, the insulating cover 161 preferably has an opening formed therethrough. The opening enables signal lines extending from the temperature sensor to be drawn out from the inside of the insulating cover 161. This modification enables the temperature sensor to be efficiently installed in the insulating cover 161.

Although not described in detail using drawings, the insulating cover 162 has substantially the same structure as that of the insulating cover 161. Specifically, the insulating cover 162, like the insulating cover 161, includes a pair of side walls 171, the outer wall 172, the axially inner wall 173, and the front wall 174. The side walls 171 constitute sides of the insulating cover 162 arranged at different positions in the circumferential direction of the stator core 62. The outer wall 172 constitutes an axially outer side of the insulating cover 162. The front wall 174 constitutes a radially inner side of the insulating cover 162. Each of the side walls 171 of the insulating cover 162 has the recess 177 disposed at a corner at the intersection of the corresponding one of the side walls 171 and the front wall 174. The recess 177 of each side wall 171 extends in the axial direction, and has a semi-circular shape in its transverse cross section. The outer wall 172 of the insulating cover 162 has a pair of protrusions 178 disposed thereon. As different points of the insulating cover 162 from the insulating cover 161, the insulating cover 162 has no openings formed therethrough for drawing out the winding ends 154 and 155 from the inside thereof.

Each of the insulating covers 161 and 162 has a predetermined height W11, W12 in the axial direction. Specifically, the insulating cover 161 has the height W11 (i.e., width of a portion of the insulating cover 161 constituted by the side walls 171 and front wall 174 in the axial direction). Similarly, the insulating cover 162 has the height W12 (i.e., width of a portion of the insulating cover 162 constituted by the side walls 171 and front wall 174 in the axial direction). As illustrated in FIG. 17, the height W11 of the insulating cover 161 is set to be larger than the height W12 of the insulating cover 162, which is expressed by the relation W11>W12. That is, if the winding segment 151A is comprised of the multiply wound conductive wire member CR, the multiply wound conductive wire member CR is comprised of many turns of the conductive wire member CR while the turns are shifted in a direction perpendicular to the winding direction of each turn. This may result in the axial width of the turns of the conductive wire member CR becomes larger. Additionally, the insulating cover 161 covers over the first link portion 153A that includes the start of winding of the multiply wound conductor wire member CR, and the end of winding of the multiply wound conductor wire member CR. This may result in the number of overlapped parts of the multiply wound conductor wire member CR in the first link portion 153A being larger, resulting in the axial width of the turns of the conductive wire member CR becoming larger. From this viewpoint, the height W11 of the insulating cover 161 is set to be larger than the height W12 of the insulating cover 162. This prevents a limitation of the number of turns of the conductor wire member CR as compared with a case where the insulating covers 161 and 162 have the same height.

Next, the following describes the configuration of the second coil module 150B.

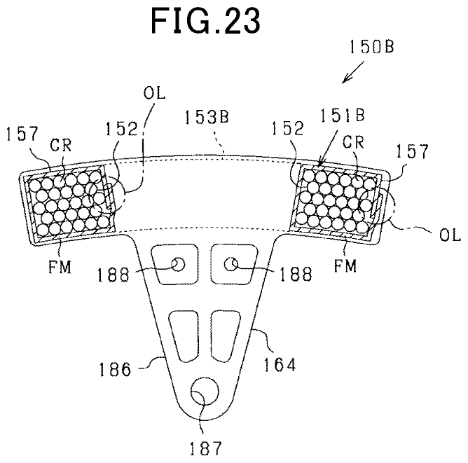

FIG. 22(a) is a perspective view of the coil module 150B, and FIG. 22(b) is an exploded perspective view of components of the first coil module 150B. FIG. 23 is a sectional view taken along the line 23-23 in FIG. 22(a).

As illustrated in FIGS. 22(a) and 22(b), the second coil module 150B includes the second winding segment 151B, and the insulating covers 163 and 164, which is similar to the first coil module 150A. The second winding segment 151B is comprised of a conductive wire member CR that is multiply wound. The insulating covers 163 and 164 are mounted on the respective first and second ends of the second winding segment 151B in the axial direction. Each of the insulating covers 163 and 164 is molded into the corresponding shape by an insulating material, such as a synthetic resin material.

The second winding segment 151B is comprised of a pair of intermediate conductor portions 152, and the pair of second link portions 153B. The intermediate conductor portions 152 are disposed to linearly extend in parallel to each other. Each of the intermediate conductor portions 152 has opposing first and second axial ends respectively correspond to the first and second axial ends of the second winding segment 151B. One of the second link portions 153B links the first axial ends of the respective intermediate conductor portions 152 to each other, and the other of the second link portions 153B links the second axial ends of the respective intermediate conductor portions 152 to each other. The assembly of the intermediate conductor portions 152 and the second link portions 153B constitutes the winding segment 151B having an annular shape. The configuration of each intermediate conductor portion 152 of the second winding segment 151B is the same as that of the corresponding intermediate conductor portion 152 of the first winding segment 151A. In contrast, the configuration of each of the second link portions 153B is different from that of the corresponding one of the first link portions 153A. Specifically, each of the second link portions 153B extends from the intermediate conductor portion 152 linearly in the axial direction without being radially bent. FIG. 18 illustrates the first winding segment 151A and the second winding segment 151B while being compared with each other.

The conductive wire member CR has both ends 154 and 155 opposite to each other. The ends 154 and 155, which will be referred to as winding ends 154 and 155, of the multiply wound conductor wire member CR are drawn out from the respective ends of one of the second link portions 153B, which is located at the second end (upper end) of the second winding segment 151B in FIG. 22(b). One of the winding ends 154 and 155 represents the start of winding of the multiply wound conductor wire member CR, and the other thereof represents the end of winding of the multiply wound conductor wire member CR. One of the winding ends 154 and 155 is connected to the current input/output (I/O) terminal, and the other of the winding ends 154 and 155 is connected to the neutral point.

Each intermediate conductor portion 152 of the second winding segment 151B is covered with the sheet-like insulating jacket 157, which is similar to the first winding segment 151A. The insulating jacket 157 is comprised of a film member FM that has a predetermined length that corresponds to an axial length of a portion of the intermediate conductor portion 152; the portion should be covered with an insulating material. The film member FM is wrapped around the intermediate conductor portion 152.

The configuration of the insulating jacket 157 of the second winding segment 151B is substantially identical to that of the insulating jacket 157 of the first winding segment 151A. Specifically, as illustrated in FIG. 23, the film member FM is wrapped around the outer peripheral surface of each intermediate conductor portion 152 while both circumferential ends of the film member FM are overlapped with each other. More specifically, each intermediate conductor portion 152 has a pair of first and second circumferential sides opposite to each other, each of which extends in a corresponding circumferential direction of the stator core 62, and a pair of first and second radial sides opposite to each other, each of which extends in a corresponding radial direction of the stator core 62. The insulating jacket 157 is wrapped around each intermediate conductor portion 152 to cover all the sides thereof. The first circumferential side of each intermediate conductor portion 152 of one phase winding faces the first circumferential side of a circumferentially adjacent intermediate conductor portion 152 of another phase winding. The overlapped portion OL of the film member FM wrapped around each intermediate conductor portion 152 of one phase winding are located on the first circumferential side of the corresponding intermediate conductor portion 152 of the one phase winding. That is, in the second winding segment 151B, the overlapped portion OL of the film member FM is located on the same first circumferential side of each of the intermediate conductor portions 152.

In the second winding segment 151B, the insulating jacket 157 wrapped around each intermediate conductor portion 152 extends between a part of the lower-side link portion 153B and a part of the upper-side link portion 153B; the part of the lower-side link portion 153B is covered with the insulating cover 164 and the part of the upper-side link portion 153B is covered with the insulating cover 163. In other words, the part of the lower-side link portion 153B is located within the insulating cover 164 and the part of the upper-side link portion 153B is located within the insulating cover 163. Referring to FIG. 17, reference character AX2 represents a portion of the second coil module 150B, which is uncovered with the insulating covers 163 and 164. The insulating jacket 157 is provided to cover over an extended portion of the second coil module 150B, which is axially wider than the portion AX2 of the second coil module 150B.

The insulating jacket 157 of the winding segment 151A extends to cover over a part of each of the link portions 153A, and the insulating jacket 157 of the winding segment 151B similarly extends to cover over a part of each of the link portions 153B. Specifically, each insulating jacket 157 of the first winding segment 151A is disposed to cover over (i) a corresponding one of the intermediate conductor portions 152 and (ii) a part of each link portion 153A, which continuously extends linearly from the corresponding one of the intermediate conductor portions 152. Because the axial length of the winding segment 151A is different from that of the winding segment 151B, the axial range of the winding segment 151A, which is covered with the insulating jacket 157, is also different from the axial range of the winding segment 151B, which is covered with the insulating jacket 157.

The following describes the structure of each of the insulating covers 163 and 164.

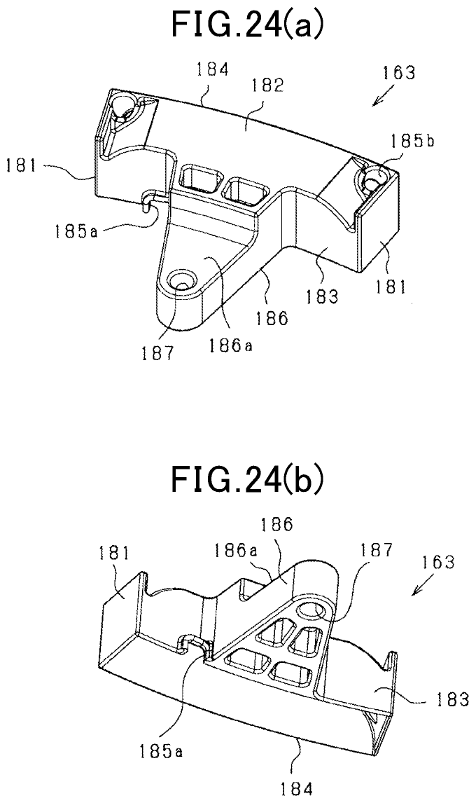

The insulating cover 163 is mounted to cover over the second link portion 153B disposed at the second end of the second winding segment 151B in the axial direction. The insulating cover 164 is mounted to cover over the second link portion 153B disposed at the first end of the second winding segment 151B in the axial direction. FIGS. 24(a) and 24(b) are perspective views respectively illustrating the insulating cover 163 as viewed from different directions.

As illustrated in FIGS. 24(a) and 24(b), the insulating cover 163 includes a pair of side walls 181, the outer wall 182, the radially inner front wall 183, and the rear wall 184. The side walls 181 constitute sides of the insulating cover 163 arranged at different positions in the circumferential direction of the stator core 62. The outer wall 182 constitutes an axially outer side of the insulating cover 163. The front wall 183 constitutes a radially inner side of the insulating cover 163. The rear wall 184 constitutes a radially outer side of the insulating cover 163. Each of the walls 181 to 184 has a plate-like shape, and are assembled to each other to have a solid shape with an axially inner opening surface. Each of the side walls 181 is disposed to be oriented toward the center axis of the core assembly CA to which the stator winding 61 including the side walls 181 is assembled. While the second coil modules 150B are arranged in the circumferential direction, the side walls 181 of each circumferentially adjacent pair of the insulating covers 163 face one another with being in contact with or adjacent to one another. This enables the second coil modules 150B to be arranged in the circumferential direction while being electrically isolated from each other.

The front wall 183 of the insulating cover 163 has the opening 185a formed therethrough from the inside of the insulating cover 163. The opening 185a enables the winding end 154 of the second winding segment 151B to be drawn out therethrough from the inside of the insulating cover 163. The outer wall 182 of the insulating cover 163 has an opening 185b formed therethrough from the inside of the insulating cover 163. The opening 185b enables the winding end 155 of the second winding segment 151B to be drawn out therethrough from the inside of the insulating cover 163.

The front wall 183 of the insulating cover 163 has the protrusion 186 protruding radially inward from the front wall 183. The protrusion 186 is disposed at the middle between the side walls 181 in the circumferential direction, and is configured to protrude more radially inward than each second link portion 153B does. That is, the protruding length of the protrusion 186 is larger than the protruding length of each second link portion 153B. The protrusion 186 has a tapered shape that becomes tapered as extending radially inward as viewed from above. The protrusion 186 has an extending end, and the through hole 187 formed through the extending end; the through hole 187 extends in the axial direction. The configuration of the protrusion 186 may be freely designed as long as

(1) The protrusion 186 protrudes more radially inward than each second link portion 153B does.

(2) The extending end of the protrusion 186 has formed therethrough the through hole 187 that is disposed at qual distances away from the side walls 181 in the circumferential direction.

Preferably, for considering an overlapped state of the protrusion 163 and the radially disposed insulating covers 161, the circumferential width of the protrusion 186 is as narrow as possible for preventing interference between the protrusion 186 and the winding ends 154 and 155.

In particular, the extending end of the protrusion 186 has an axial thickness smaller than an axial thickness of the remaining portion of thereof. The extending end of the protrusion 186, which has a smaller thickness, is defined as a low-height portion 186a. The low-height portion 186a of the protrusion 186 has the through hole 187 formed therethrough. The axial height of the low-height portion 186a of the protrusion 186 of each second coil module 150B relative to the end surface of the first end of the inner cylindrical member 81 is lower than the axial height of the upper link portion 153B of the corresponding second coil module 150B while the second coil modules 150B are assembled to the core assembly CA.

As illustrated in FIG. 23, the remaining part of the protrusion 186 has a pair of through holes 188 formed therethrough. The through holes 188 of the protrusion 186 enable, while the insulating covers 161 and 163 are axially overlapped with each other, adhesive to be applied through the through holes 188. This results in the applied adhesive being filled between the axially overlapped insulating covers 161 and 163.

Although omitted in the drawings, the insulating cover 164 has substantially the same structure as that of the insulating cover 163. Specifically, the insulating cover 164, like the insulating cover 163, includes a pair of side walls 181, the outer wall 182, the radially inner front wall 183, and the rear wall 184. The side walls 181 constitute sides of the insulating cover 164 arranged at different positions in the circumferential direction of the stator core 62. The outer wall 182 constitutes an axially outer side of the insulating cover 164. The front wall 183 constitutes a radially inner side of the insulating cover 164. The rear wall 184 constitutes a radially outer side of the insulating cover 164. The front wall 183 of the insulating cover 164 has the protrusion 186 protruding radially inward from the front wall 183. The protrusion 186 has the through hole 187 formed through the extending end. As different points of the insulating cover 164 from the insulating cover 163, the insulating cover 164 has no openings formed therethrough for drawing out the winding ends 154 and 155 of the second winding segment 151B from the inside thereof.

Each side wall 181 of the insulating cover 163 has a predetermined radial width W21, and each side wall 181 of the insulating cover 164 has a predetermined radial width W22. Specifically, as illustrated in FIG. 17, the radial width W21 of the insulating cover 163 is set to be larger than the radial width W22 of the insulating cover 164, which is expressed by the following relation “W21>W22”. That is, if the winding segment 151B is comprised of the multiply wound conductive wire member CR, the insulating cover 163 covers over the second link portion 153B that includes the start of winding of the multiply wound conductor wire member CR, and the end of winding of the multiply wound conductor wire member CR. This may result in the number of overlapped parts of the multiply wound conductor wire member CR in the second link portion 153B being larger, resulting in the axial width of the turns of the conductive wire member CR becoming larger. From this viewpoint, the radial width W21 of the insulating cover 163 is set to be larger than the radial width W22 of the insulating cover 164. This prevents a limitation of the number of turns of the conductor wire member CR as compared with a case where the insulating covers 163 and 164 have the same radial width.

FIG. 25 is a view illustrating how the overlapped portions OL of the respective film members FM are arranged while the coil modules 150A and 150B are circumferentially arranged. As described above, the film member FM is wrapped around the outer peripheral surface of each intermediate conductor portion 152 of each coil module 150A, 150B while

(1) Both circumferential ends of the film member FM are overlapped with each other as the overlapped portion OL

(2) The overlapped portion OL of the film member FM is located at the first circumferential side of the corresponding intermediate conductor portion 152; the first circumferential side faces the intermediate conductor portion 152 of another phase (see FIGS. 20 and 23).

This results in the overlapped portion OL of each film member FM being located on the same side, i.e., the right side in FIG. 25, of the corresponding intermediate conductor portion 152 in the circumferential direction. This therefore results in the overlapped portion OL of the film member FM of the intermediate conductor portion 152 of a one-phase winding segment 151A and the overlapped portion OL of the film member FM of the intermediate conductor portion 152 of another-phase winding segment 151B, which is circumferentially adjacent to the one-phase winding segment 151A, being circumferentially not overlapped with each other. Between the circumferentially adjacent pair of intermediate conductor portions 152, at most three parts of the film members FM are located.

Next, the following describes the structure of the coil modules 150A and 150B being assembled to the core assembly CA.

The axial length of the coil module 150A is different from that of the coil module 150B, and the configuration of each link portion 153A of the coil module 150A is different from that of the corresponding link portion 153B of the coil module 150B. The coil modules 150A and 150B are assembled to the core assembly CA while the first link portions 153A of each coil module 150A are disposed radially closer to the core assembly CA and the second link portions 153B of each coil module 150B are disposed radially farther from the core assembly CA. The insulating covers 161 to 164 are secured to the core assembly CA while the insulating covers 161 and 163 are axially overlapped with each other at the second end of the core assembly CA and the insulating covers 162 and 164 are axially overlapped with each other at the first end of the core assembly CA.

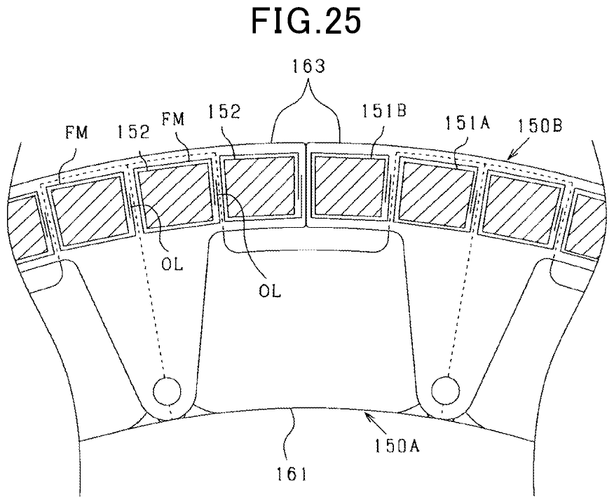

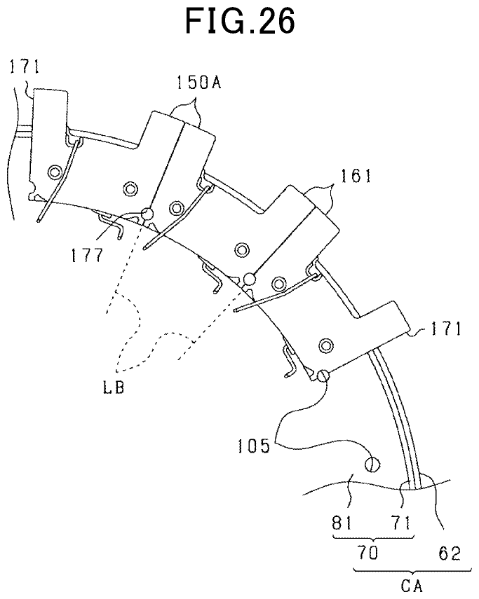

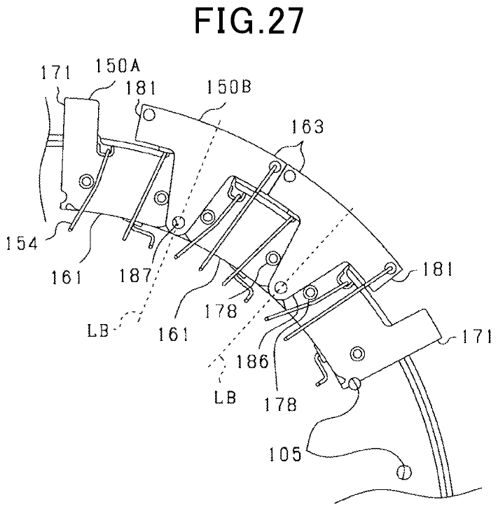

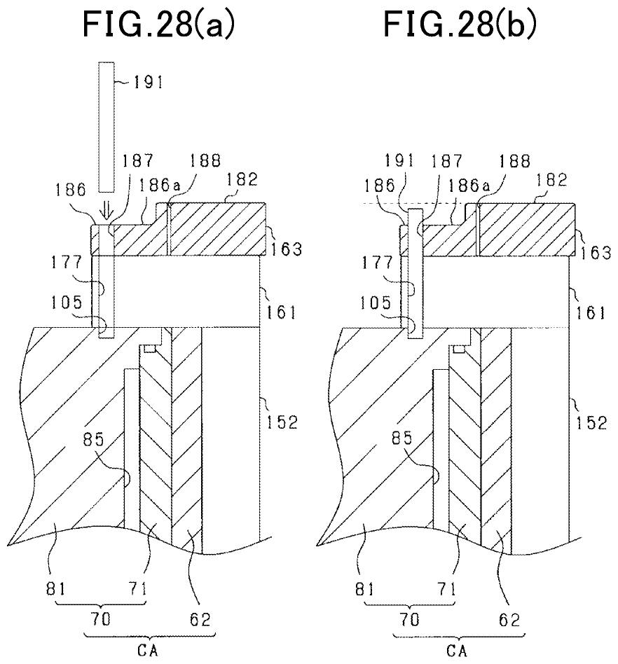

FIG. 26 is a plan view illustrating that the insulating covers 161 are circumferentially arranged while the first coil modules 150A are assembled to the core assembly CA. FIG. 27 is a plan view illustrating that the insulating covers 161 and 163 are circumferentially arranged while the first and second coil modules 150A and 150B are assembled to the core assembly CA. FIG. 28(a) is a longitudinal sectional view illustrating that the coil modules 150A and 150B are assembled to the core assembly CA before fastening of the insulating covers 161 and 163 to the core assembly CA using fastening pins 191. FIG. 28(b) is a longitudinal sectional view illustrating that the coil modules 150A and 150B are assembled to the core assembly CA after fastening of the insulating covers 161 and 163 to the core assembly CA using the fastening pins 191.

As illustrated in FIG. 26, while the first coil modules 150 are assembled to the core assembly CA, the insulating covers 161 are circumferentially arranged such that the side walls 171 of each circumferentially adjacent pair of the insulating covers 161 face one another with being in contact with or adjacent to one another. Each circumferentially adjacent pair of the insulating covers 161 is arranged such that a boundary line LB extending along the facing side walls 171 is axially aligned with a corresponding one of the recesses 105 formed in the outer surface of the end plate 91 of the inner cylindrical member 81. Since the side walls 171 of each circumferentially adjacent pair of the insulating covers 161 are in contact with or adjacent to one another, the recesses 177 of each circumferentially adjacent pair of the insulating covers 161 form a through hole extending in the axial direction. The through hole formed in each circumferentially adjacent pair of the insulating covers 161 is axially aligned with the corresponding one of the recesses 105 of the end plate 91 of the inner cylindrical member 81.

The second coil modules 150B are, as illustrated in FIG. 27, assembled to the assembly of the first coil modules 150A and the core assembly CA. This assembling of the second coil modules 150B to the core assembly CA results in the side walls 181 of each circumferentially adjacent pair of the insulating covers 163 facing one another with being in contact with or adjacent to one another. This assembling of the second coil modules 150B to the core assembly CA also results in the link portions 153A and 153B intersecting with each other on a virtual circle along which the intermediate conductor portions 152 are circumferentially arranged while the assembly of the coil modules 150A and 150B and the core assembly CA is viewed above. Each insulating cover 163 is disposed such that

(1) The protrusion 186 is axially overlapped with a boundary of a corresponding circumferentially adjacent pair of the insulating covers 161

(2) The through hole 187 is axially aligned with the through hole defined by the recesses 177 of a corresponding one circumferentially adjacent pair of the insulating covers 161.

When the second coil modules 150B are assembled to the assembly of the first coil modules 150A and the core assembly CA, the protrusion 186 of each insulating cover 163 is guided by the protrusions 178 of a corresponding circumferentially adjacent pair of insulating covers 161. This results in the through hole 187 of the protrusion 186 of each insulating cover 163 being axially aligned with

(1) The through hole defined by the recesses 177 of a corresponding one circumferentially adjacent pair of the insulating covers 161

(2) A corresponding one of the recesses 105 of the end plate 91 of the inner cylindrical member 81

When the coil modules 150B are assembled to the assembly of the core assembly CA and the coil modules 150A, the through hole defined by the recesses 177 of each circumferentially adjacent pair of the insulating covers 161 is located inwardly. There may be therefore a concern that it is difficult to axially align the through hole 187 of the protrusion 186 of each insulating cover 163 with the through hole defined by the recesses 177 of a corresponding circumferentially adjacent pair of the insulating covers 161. Regarding such a concern, the protrusion 186 of each insulating cover 163 is guided by the protrusions 178 of a corresponding circumferentially adjacent pair of insulating covers 161. This makes it possible to easily axially align the through hole 187 of the protrusion 186 of each insulating cover 163 with the through hole defined by the recesses 177 of a corresponding one circumferentially adjacent pair of the insulating covers 161.

Joining of the insulating cover 161 and the insulating cover 613 is, as illustrated in FIGS. 28(a) and 28(b), achieved by the fastening pin 191 at an overlap of the insulating cover 161 with the protrusion 186 of the insulating cover 163. Specifically, such joining is accomplished by aligning the recess 105 of the inner cylindrical member 81, the recess 177 of the insulating cover 161, and the through hole 187 of the insulating cover 163 with each other and then inserting the fastening pin 191 into them, thereby firmly securing the insulating covers 161 and 163 to the inner cylindrical member 81. This results in joint of a respective circumferentially adjacent coil modules 150A and 150B to the core assembly CA at the coil end CE using the common fastening pin 191. It is advisable that each of the fastening pins 191 be made from high-thermal conductive material, such as metal.

As illustrated in FIG. 28(b), the fastening pin 191, which has opposing upper and lower ends in its axial direction, for each insulating cover 163 is mounted through the low-height portion 186a of the corresponding insulating cover 163. In this state, the upper end of the fastening pin 191 is disposed to project over the low-height portion 186a while being axially lower than an outer surface, i.e., an upper surface, of the outer wall 182 of the insulating cover 163. The fastening pin 191 has a length in its axial direction, and the length of the fastening pin 191 is larger than the axially overlapped portion of the low-height portion 186a of the protrusion 186 and the insulating cover 161, so that the upper end of the fastening pin 191, which projects over the low-height portion 186a, serves as a margin. The margin of the fastening pin 191 enables, for insertion of each fastening pin 191 through the corresponding through hole 187 and the corresponding through hole formed by the recesses 177 into the corresponding recess 105, the corresponding fastening pin 191 to be easily inserted through the corresponding through hole 187 and the corresponding through hole formed by the recesses 177 into the corresponding recess 105. The upper end of the fastening pin 191 is disposed to be axially lower than the outer surface 173, i.e., the upper surface, of the insulating cover 163. This prevents an increase in the axial length of the stator 60 due to the projecting fastening pins 191.

After the insulating covers 161 and 163 are fastened to the core assembly CA using the fastening pins 191, adhesive is applied through the through holes 188 of the insulating cover 163, so that the applied adhesive is filled between the axially overlapped insulating covers 161 and 163. This results in the axially overlapped insulating covers 161 and 163 being strongly joined to each other. For the sake of simplicity, FIGS. 28(a) and 28(b) illustrate the through holes 188 as being formed through the remaining part of the protrusion 186 except the low-height portion 186a of the insulating cover 163 between the outer surface (upper surface) of the outer wall 182 and an outer surface, i.e., a lower surface) of a bottom wall of the insulating cover 163; the bottom wall is opposite to the outer wall 182. Actually, the through holes 188 may be formed through a thinner-thickness part of the protrusion 186; the thinner-thickness part of the protrusion 186 is smaller in axial thickness than the remaining of the protrusion 186.

The securement of the insulating covers 161 and 163 using the fastening pin 191 is, as illustrated in FIG. 28(b), achieved on the axial end surface of the stator holder 70 which is located radially inside the stator core 62 (i.e., the left side of the drawing). The insulating covers 161 and 163 are attached to the stator holder 70 using the fastening pin 191. In other words, the first link portions 153A are fixed on the axial ends of the stator holder 70. The stator holder 70 has the coolant path 85 therein, so that heat generated from the first winding segments 151A will be transferred directly from the first upper link portions 153A to the coolant path 85 of the stator holder 70 or a region of the stator holder 70 around the coolant path 85. Additionally, each fastening pin 191 is disposed in a corresponding one of the recesses 105 of the stator holder 70, thereby facilitating the transfer of heat to the stator holder 70 through the corresponding fastening pin 191. The above configuration of the rotating electrical machine 10, therefore, has a higher performance of cooling the stator winding 61.

Eighteen insulating covers 161 and eighteen insulating covers 163 are arranged to be axially overlapped with one another; the axially overlapped insulating covers 161 and 173 constitute the coil end CE. Eighteen recesses 105 are formed in the outer surface of the stator holder 70. The eighteen insulating covers 161 and eighteen insulating covers 163 are secured to the core assembly CA at the respective eighteen recesses 105 and eighteen fastening pins 191.

How the insulating covers 162 and 164 are assembled to the first end of the core assembly CA in the axial direction, which is although unillustrated, is similar to how the insulating covers 161 and 163 are assembled to the second end of the core assembly CA in the axial direction. Specifically, the securement of the first coil modules 150A is first achieved by placing the side walls 171 of the respective circumferentially adjacent insulating covers 162 in contact with or close to each other to define an axially extending through hole by the recesses 177 of the insulating covers 162. The axially extending through hole is aligned with a corresponding one of the recesses 106 formed in the axial end of the outer cylindrical member 71. The securement of each of the second coil module 150B is achieved to align the through-hole 187 of the insulating cover 164 with the through-hole of the insulating cover 163 and the recess 106 of the outer cylindrical member 71. The fastening pin 191 is inserted into the recesses 106 and 177 and the through-hole 187, thereby firmly attaching the insulating covers 162 and 164 to the outer cylindrical member 71.

Preferably, all the coil modules 150A are assembled to the outer peripheral surface of the core assembly CA, and thereafter all the coil modules 150B are assembled to the outer peripheral surface of the core assembly CA and the insulating covers 161 to 164 are fastened to the core assembly CA using the fastening pins 191. Alternatively, a first step of fastening a pair of one first coil module 150A and one second col module 150B to one another using one fastening pin 191 is carried out. Next, a second step of assembling, to the outer peripheral surface of the core assembly CA, the first coil module 150A and second coil module 150B fastened to each other by the fastening pin 191 is carried out. Then, the first step and second step are repeatedly carried out.

Next, the following describes the busbar module 200.

The busbar module 200 is electrically connected to the winding segments 151 of the coil modules 150, so that

(1) First ends of the winding segments 151 for the U-phase are connected in parallel to each other

(2) First ends of the winding segments 151 for the V-phase are connected in parallel to each other

(3) First ends of the winding segments 151 for the W-phase are connected in parallel to each other

(4) Second ends, which are opposite to the first ends, of the winding segments 151 for all the phases are connected to each other at a neutral point.

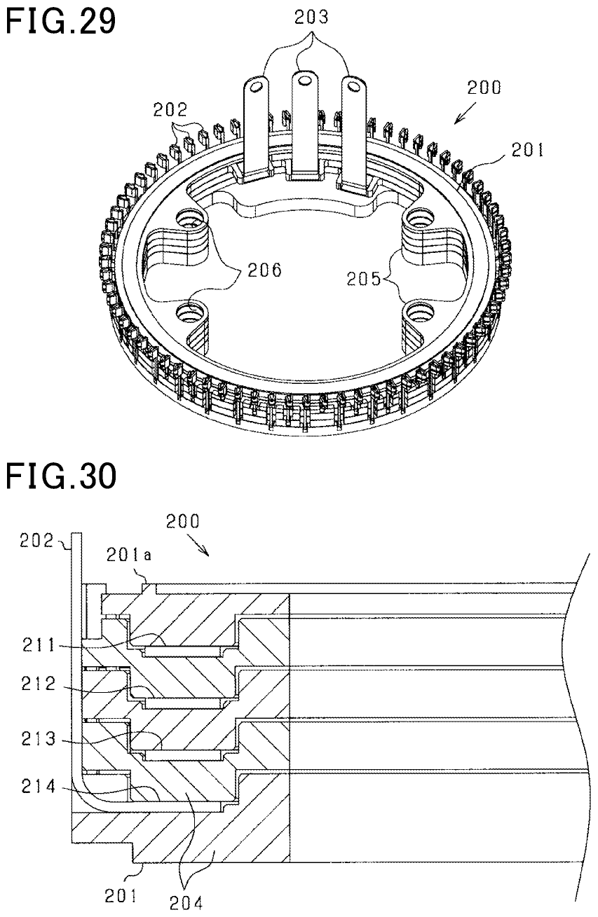

FIG. 29 is a perspective view of the busbar module 200. FIG. 30 is a longitudinal sectional view of a part of the busbar module 200.

The busbar module 200 includes the annular ring 201, a plurality of connection terminals 202, and three input/output (I/O) terminals 203 provided for the respective phase windings. The connection terminals 202 extend from the annular ring 201. The annular ring 201 is made of an insulating member, such as resin, in a circular shape.

The annular ring 201, as illustrated in FIG. 30, includes a plurality of, i.e., five in this modification, substantially annular plates 204 stacked in the same axial direction. The annular plates 204 will be also referred to as substantially annular stacked plates 204. The busbar module 200 also includes four busbars 211 to 214. Each of the busbars 211 to 214 is interposed between a corresponding axially adjacent pair of annular stacked plates 204. Each of the busbars 211 to 214 has an annular shape. The busbars 211 to 214 include a U-phase busbar 211, a V-phase busbar 212, a W-phase busbar 213, and a neutral-point busbar 214. These busbars 211 to 214 are aligned in the axial direction of the annular ring 201 while their major surfaces face each other. Each of the busbars 211 to 214 is adhered to a corresponding axially adjacent pair of annular stacked plates 204. For example, adhesive sheets are preferably used for bonding each of the busbars 211 to 214 to a corresponding axially adjacent pair of annular stacked plates 204. Semi-liquid adhesive or liquid adhesive may alternatively be applied to opposing major surfaces of each stacked plate 204 for bonding each of the busbars 211 to 214 to a corresponding axially adjacent pair of annular stacked plates 204. First ends of the connection terminals 202 are each connected to a corresponding one of the busbars 211 to 214 in the annular ring 201, and second ends of the connection terminals 202 protrude radially outside the annular ring 201.

An upper surface of the annular ring 201, that is, an outermost one of the five stacked plates 204 has formed thereon the protrusion 201a which extends in an annular shape.

The busbar module 200 may be designed as long as the busbars 211 to 214 are embedded in the annular ring 201. For example, the annular ring 201 and the busbars 211 to 214 arranged at regular intervals may be integrally insert molded. Although the busbars 211 to 214 of the busbar module 200 are aligned in the axial direction while the bar surface of each busbar 211 to 214 is perpendicular to the axial direction, but the arrangement of the busbars 211 to 214 may be optionally selected. For example, the busbars 211 to 214 of the busbar module 200 are aligned in the radial direction. Two of the busbars 211 to 214 may alternatively be aligned in the axial direction, and the remaining two thereof may be aligned in the radial direction. The busbars 211 to 214 may extend in respective directions.

The connection terminals 202 are, as illustrated in FIG. 29, aligned in the circumferential direction of the annular ring 201. Each of the connection terminals 202 extends in the axial direction of the annular ring 201 radially outside the bus bar module 200. The connection terminals 202 include connection terminals connected to the U-phase busbar 211, connection terminals connected to the V-phase busbar 212, connection terminals connected to the W-phase busbar 213, and connection terminals connected to the neutral-point busbar 214. The number of connection terminals 202 is set to be identical to the number of winding ends 154 and 155 of the winding segments 151 of the coil modules 150, so that the connection terminals 202 are respectively connected to the winding ends 154 and 155. This results in the busbar module 200 being connected to each of the U-phase winding segments 151, the V-phase winding segments 151, and the W-phase winding segments 151.

The I/O terminals 203 are made of, for example, a busbar material and extend in the axial direction. The I/O terminals 203 include a U-phase I/O terminal 203U, a V-phase I/O terminal 203V, and a W-phase I/O terminal 203W. The U-phase I/O terminal 203U, V-phase I/O terminal 203V, and W-phase I/O terminal 203W are connected to the respective U-phase busbar 211, V-phase busbar 212, and W-phase busbar 213 in the annular ring 201. Electrical power is inputted to each-phase winding of the stator winding 61 from an unillustrated inverter through a corresponding one of the I/O terminals 203. Electrical power is outputted to the unillustrated inverter from each-phase winding of the stator winding 61 from an unillustrated inverter through a corresponding one of the I/O terminals 203.

Current sensors may be integrally installed in the busbar module 200 for respectively measuring a U-phase current, a V-phase current, and a W-phase current. In this case, current measurement terminals may be provided for the busbar module 200. Electrical current information measured by each current sensor may be output to an unillustrated controller through a corresponding one of the current measurement terminals.

The annular ring 201 has an inner peripheral surface, and protrusions 205 extending radially inward from the inner peripheral surface. Each of the protrusions 205 serves as a fixture to be fixed to the stator holder 70. Each of the protrusions 205 has an extending end, and the through hole 206 formed through the extending end thereof. The through hole 206 of each protrusion 205 extends in the axial direction of the annular ring 201.

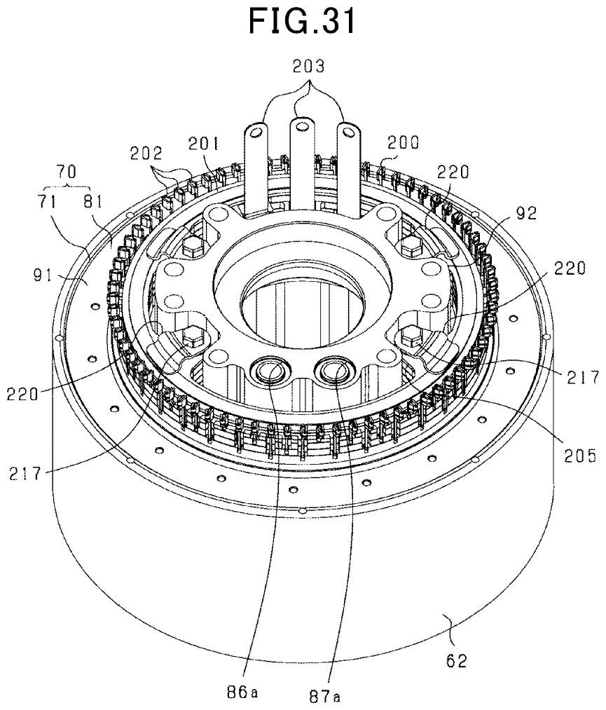

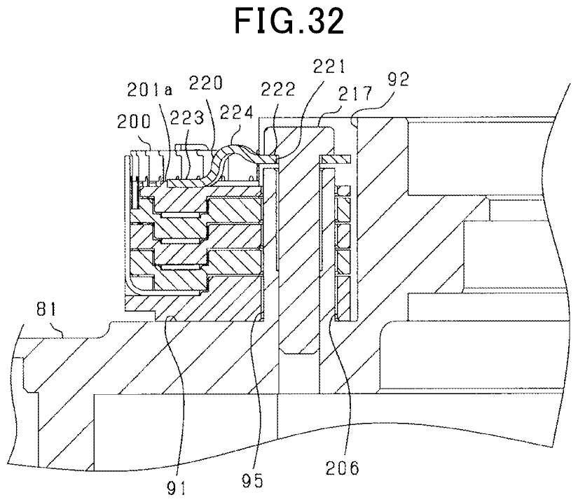

FIG. 31 is a perspective view illustrating the busbar module 200 assembled to the stator holder 70. FIG. 32 is a longitudinal sectional view illustrating how the busbar module 200 is fixed to the stator holder 70. The structure of the stator holder 70 before the busbar module 200 is assembled to the stator holder 70 is illustrated in FIG. 12.

The busbar module 200 is, as illustrated in FIG. 31, mounted on the end plate 91 and surrounds the boss 92 of the inner cylindrical member 81. The busbar module 200 is assembled to the rods 95 (see FIG. 12), so that the busbar module 200 is positioned. The busbar module 200 is then assembled to the inner cylindrical member 81 of the stator holder 70 using fasteners 217, such as bolts.

More specifically, as illustrated in FIG. 32, the rods 95 are mounted on the end plate 91 of the inner cylindrical member 81 and located radially outside the boss 92. Each of the rods 95 extends from the end plate 91 in the axial direction of the end plate 91. The busbar module 200 is secured by the fasteners 217 to the rods 95 with the rods 95 inserted into the through-holes 206 formed in the protrusions 205. In this embodiment, the securement of the busbar module 20 is achieved using the retainer plates 220 made from metallic material, such as iron. Each of the retainer plates 220 includes the mating fastener portion 222, the press portion 223, and the bent 224. The mating fastener portion 222 has formed therein the through-hole 221 through which the fastener 217 passes. The press portion 223 works to press the upper surface of the annular ring 201 of the busbar module 200. The bent 224 is located between the mating fastener portions 222 and the press portion 223.

Each of the retainer plates 220 is disposed on the annular ring 201 with the fastener 217 inserted into the through-hole 221 of the retainer plate 220 and threadedly engaging the rods 95 of the inner cylindrical member 81. The press portion 223 of the retainer plate 220 is placed in contact with the upper surface of the annular ring 201 of the busbar module 200. The screwing of the fasteners 217 into the rods 95 causes the retainer plates 220 to be pressed downward, as viewed in the drawing, so that the annular ring 201 is pressed downward by the press portions 223. The downward pressure, as produced by the screwing of each of the fasteners 217, is transmitted to the press portion 223 through the bent 224, so that the annular ring 201 is pressed by the press portion 223 with the aid of elastic pressure created by the bent 224.

The annular ring 201, as described above, has the annular protrusion 201a disposed on the upper surface thereof. The head (i.e., the press portion 223) of each of the retainer plates 220 is contactable with the annular protrusion 201a. This eliminates a risk that the downward pressure produced by the retainer plate 220 may be dispersed radially outward, thereby ensuring the stability in transmitting the pressure, as produced by the tightening of the fasteners 217, to the press portions 223.

After the busbar module 200 is secured to the stator holder 70, the I/O terminals 203 are, as illustrated in FIG. 31, disposed to be circumferentially 180 degrees opposite to the inlet opening 86a and the outlet opening 87a that communicate with the coolant path 85. The I/O terminals 203 and the inlet and outlet openings 86a and 87a may alternatively be disposed to be close to each other.

Next, the following describes the lead member 230 that electrically connects the I/O terminals 203 of the busbar module 200 to an external device of the rotating electrical machine 10.

The rotating electrical machine 10 is, as illustrated in FIG. 1, configured to have the I/O terminals 203 of the busbar module 200 disposed to project outward from the housing cover 242. The I/O terminals 203 are connected to the lead member 230 outside the housing cover 242. The lead member 230 is configured to connect the I/O terminals 203 for the respective phases extending from the busbar module 200 to power lines for the respective phases extending from an external apparatus, such as an inverter.

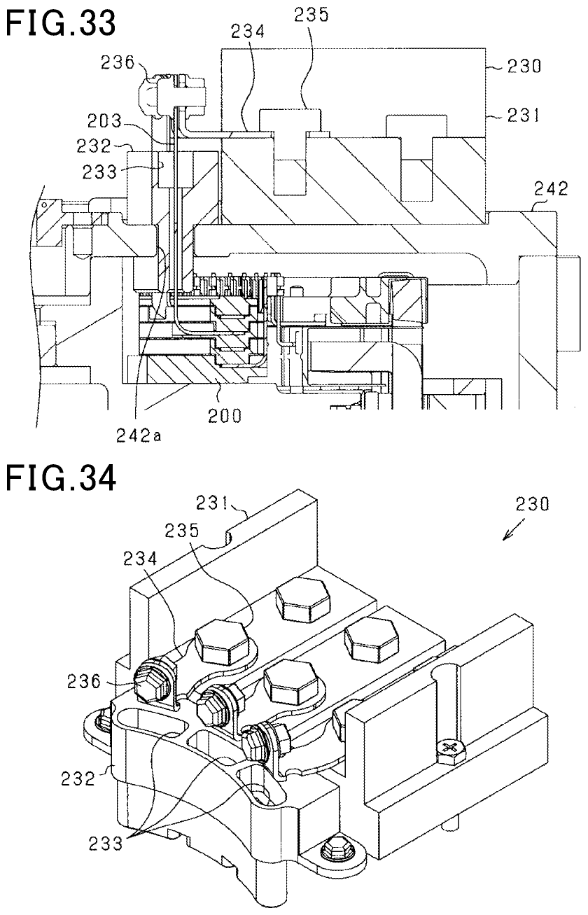

FIG. 33 is a longitudinal sectional view illustrating the housing cover 242 to which the lead member 230 is mounted. FIG. 34 is a perspective view of the lead member 230. The housing cover 242, as can be seen in FIG. 34, has the through holes 242a formed therethrough. The through holes 242a enable the I/O terminals 203 to be drawn out from the inside of the housing cover 242.

The lead member 230 includes the base 231 secured to the housing cover 242 and the terminal plug 232 fit in the through-hole 242a of the housing cover 242. The terminal plug 232 has formed therein three through-holes 233 through which the three I/O terminals 203 for the respective phases pass. The through-holes 233 are shaped to have elongated sections which are substantially aligned with each other.

The base 231 has mounted thereon three lead busbars 234 for the respective phases. Each of the lead busbars 234 is bent in an L-shape and secured to the base 231 using the fastener 235, such as a bolt. Each of the lead busbars 234 is also connected using the fastener 236, such as a combination of a bolt and a nut, to the head of the I/O terminal 203 disposed in a corresponding one of the through-holes 233 of the terminal plug 232.

To the lead member 230, unillustrated three-phase power wires can be connected. This enables power to be input to or output from each of the three-phase I/O terminals 203.

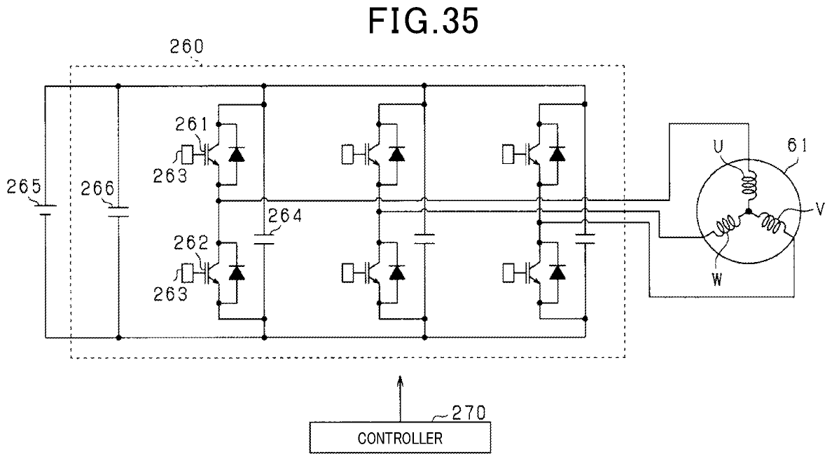

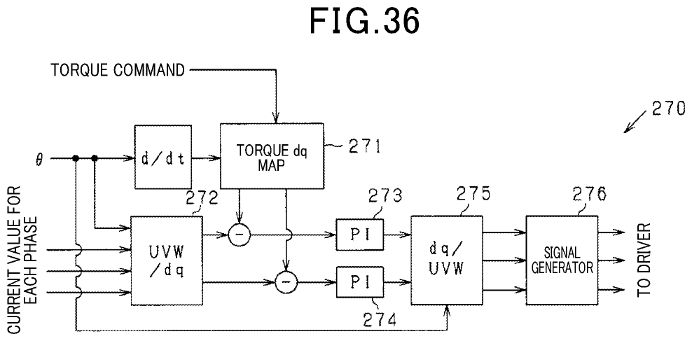

The structure of a control system for controlling an operation of the rotating electrical machine 10 will be described below. FIG. 35 is an electrical circuit diagram of the control system for the rotating electrical machine 10. FIG. 36 is a functional block diagram which illustrates control steps performed by the controller 270.

The stator winding 61 is, as illustrated in FIG. 35, made up of a U-phase winding, a V-phase winding, and a W-phase winding. The stator winding 61 connects with the inverter 260 working as a power converter. The inverter 260 is made of a bridge circuit having as many upper and lower arms as the phases of the stator winding 61. The inverter 260 is equipped with a series-connected part made up of the upper arm switch 261 and the lower arm switch 262 for each phase. Each of the switches 261 and 262 is turned on or off by a corresponding one of the driver circuits 263 to energize or deenergize a corresponding one of the phase windings. Each of the switches 261 and 262 is made of, for example, a semiconductor switch, such as a MOSFET or IGBT. The capacitor 264 is also connected to each of the series-connected parts made up of the switches 261 and 262 to output electrical charge required to achieve switching operations of the switches 261 and 262.

Intermediate joints of the upper arm switches 261 and the lower arm switches 262 are connected to ends of the U-phase winding, the V-phase winding, and the W-phase winding. The U-phase winding, the V-phase winding, and the W-phase winding are connected in the form of a star connection (i.e., Y-connection). The other ends of the U-phase winding, the V-phase winding, and the W-phase winding are connected with each other at a neutral point.

The control device 270 serves as a controller and is made up of a microcomputer equipped with a CPU and memories. The control device 270 analyzes information about parameters sensed in the rotating electrical machine 10 or a request for a motor mode or a generator mode in which the rotating electrical machine 10 operates to control switching operations of the switches 261 and 262 to excite or deexcite the stator winding 61. The parameters derived about the rotating electrical machine 10 include an angular position (i.e., electrical angle) of the rotor 20 measured by an angle detector, such as a resolver, the voltage at a power supply (i.e., voltage inputted to the inverter) measured by a voltage sensor, and/or exciting current for each phase winding measured by a current sensor. For instance, the control device 270 performs a PWM operation at a given switching frequency (i.e., carrier frequency) or an operation using a rectangular wave to turn on or off the switches 261 and 262. The control device 270 may be designed as a built-in controller installed inside the rotating electrical machine 10 or an external controller located outside the rotating electrical machine 10.

The rotating electrical machine 10 in this embodiment has a decreased electrical time constant because the rotating electrical machine 10 is of a slot-less structure (i.e., tooth-less structure), so that the stator 60 has a decreased inductance. In terms of the decreased electrical time constant, it is preferable to increase the switching frequency (i.e., carrier frequency) to enhance the switching speed in the rotating electrical machine 10. In terms of such requirements, the capacitor 264 serving as a charge supply capacitor is connected parallel to the series-connected part made up of the switches 261 and 262 for each phase of the stator winding 61, thereby reducing the wiring inductance, which deals with electrical surges even through the switching speed is enhanced.

The inverter 260 is connected at a high potential terminal thereof to a positive terminal of the dc power supply 265 and at a low potential terminal thereof to a negative terminal (i.e., ground) of the dc power supply 265. The dc power supply 265 is made of, for example, an assembly of a plurality of electrical cells connected in series with each other. The smoothing capacitor 266 is connected to the high and low potential terminals of the inverter 260 in parallel to the dc power supply 265.

FIG. 36 is a block diagram which illustrates a current feedback control operation to control electrical currents delivered to the U-phase winding, the V-phase winding, and the W-phase winding.

In FIG. 36, the current command determiner 271 uses a torque-dq map to determine current command values for the d-axis and the q-axis using a torque command value in the motor mode of the rotating electrical machine 10 (which will also be referred to as a motor-mode torque command value), a torque command value in the generator mode of the rotating electrical machine 10 (which will be referred to as a generator-mode torque command value), and an electrical angular velocity ω derived by differentiating an electrical angle θ with respect to time. The generator-mode torque command value is a regenerative torque command value in a case where the rotating electrical machine 10 is used as a power source of a vehicle.

The d-q converter 272 works to convert currents (i.e., three phase currents), as measured by current sensors mounted for the respective phase windings, into a d-axis current and a q-axis current that are components in a two-dimensional rotating Cartesian coordinate system in which a d-axis is defined as a direction of an axis of a magnetic field or field direction.

The d-axis current feedback control device 273 determines a command voltage for the d-axis as a manipulated variable for bringing the d-axis current into agreement with the current command value for the d-axis in a feedback mode. The q-axis current feedback control device 274 determines a command voltage for the q-axis as a manipulated variable for bringing the q-axis current into agreement with the current command value for the q-axis in a feedback mode. The feedback control devices 273 and 274 calculate the command voltage as a function of a deviation of each of the d-axis current and the q-axis current from a corresponding one of the current command values using PI feedback techniques.

The three-phase converter 275 works to convert the command values for the d-axis and the q-axis into command values for the U-phase, V-phase, and W-phase windings. Each of the devices 271 to 275 is engineered as a feedback controller to perform a feedback control operation for a fundamental current in the d-q transformation theory. The command voltages for the U-phase, V-phase, and W-phase windings are feedback control values.

The operation signal generator 276 uses the known triangle wave carrier comparison to produce operation signals for the inverter 260 as a function of the three-phase command voltages. Specifically, the operation signal generator 276 works to produce switch operation signals (i.e., duty signals) for the upper and lower arms for the three-phase windings (i.e., the U-, V-, and W-phase windings) under PWM control based on comparison of levels of signals derived by normalizing the three-phase command voltages using the power supply voltage with a level of a carrier signal, such as a triangle wave signal. The switch operation signals produced by the operation signal generator 276 are outputted to the drivers 263 of the inverter 260. The drivers 263 turn on or off the switches 261 and 263 for the phase windings.

Subsequently, a torque feedback control operation will be described below. This operation is to increase an output of the rotating electrical machine 10 and reduce torque loss in the rotating electrical machine 10, for example, in a high-speed and high-output range wherein an output voltage from the inverter 260 rises. The controller 270 selects one of the torque feedback control operation and the current feedback control operation and perform the selected one as a function of an operating condition of the rotating electrical machine 10.

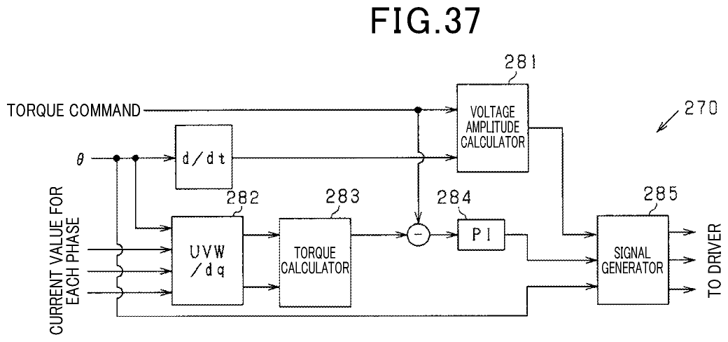

FIG. 37 shows the torque feedback control operation for the U-, V-, and W-phase windings.

The voltage amplitude calculator 281 works to calculate a voltage amplitude command that is a command value of a degree of a voltage vector as a function of the motor-mode torque command value or the generator-mode torque command value for the rotating electrical machine 10 and the electrical angular velocity ω derived by differentiating the electrical angle θ with respect to time.

The d-q converter 282, like the d-q converter 272, works to convert currents, as measured by current sensors mounted for the respective phase windings, into a d-axis current and a q-axis current that are components. The torque calculator 283 calculates a torque value in the U-phase, V-phase, or the W-phase as a function of the d-axis current and the q-axis current converted by the d-q converter 282. The torque calculator 283 may be designed to calculate the voltage amplitude command using map listing relations among the d-axis current, the q-axis current, and the voltage amplitude command.

The torque feedback controller 284 calculates a voltage phase command that is a command value for a phase of the voltage vector as a manipulated variable for bringing the estimated torque value into agreement with the motor-mode torque command value or the generator-mode torque command value in the feedback mode. Specifically, the torque feedback controller 284 calculates the voltage phase command as a function of a deviation of the estimated torque value from the motor-mode torque command value or the generator-mode torque command value using PI feedback techniques.

The operation signal generator 285 works to produce the operation signal for the inverter 260 using the voltage amplitude command, the voltage phase command, and the electrical angle θ. Specifically, the operation signal generator 285 calculates the command values for the three-phase windings based on the voltage amplitude command, the voltage phase command, and the electrical angle θ and then generates switching operation signals for the upper and lower arms for the three-phase windings by means of PWM control based on comparison of levels of signals derived by normalizing the three-phase command voltages using the power supply voltage with a level of a carrier signal, such as a triangle wave signal. The switching operation signals produced by the operation signal generator 285 are then outputted to the drivers 263 of the inverter 260. The drivers 263 turns on or off the switches 261 and 262 for the phase windings.

The operation signal generator 285 may alternatively be designed to produce the switching operation signals using pulse pattern information that is map information about relations among the voltage amplitude command, the voltage phase command, the electrical angle θ, and the switching operation signal, the voltage amplitude command, the voltage phase command, and the electrical angle θ.

### Modifications

Modifications of the above embodiment will be described below.

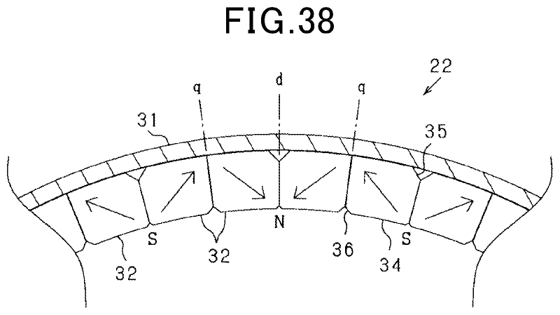

The arrangement of the magnets of the magnet unit 22 may be modified in the following way. The magnets 32 of the magnet unit 22 illustrated in FIG. 38 are each configured to have an easy axis of magnetization which is oblique to the radial direction of the magnet unit 22 and along which a magnetic path is created to extend linearly. This structure also enables the magnetic path created in each of the magnets 32 to have a length greater than the dimension or thickness of the magnets 32 in the radial direction, thereby enhancing the permeance in the magnets 32.

The magnet unit 22 may alternatively be engineered to have a Halbach array.

Each of the link portions 151 of each winding segment 151 may be bent to extend toward the radially inward or radially outward. Specifically, each first link portion 153A may be bent to be closer to the core assembly CA or farther away therefrom. Each second link portion 153B may be bent as long as the bent second link 153B circumferentially intersects with a part of the first link portion 153A at the axially outer side of the first link portion 153A.

The winding segments 151 may include only one of the first type of winding segments 151A and the second type of winding segments 151B. Specifically, each winding segment 151 may have a substantially L-shape or Z-shape as viewed from the side thereof. When each winding segment 151 is shaped to have a substantially L-shape, one of the link portions of the corresponding winding segment 151 at one of the first and the second ends may be bent toward the radially inward or radially outward, and the other of the link portions may extend without being bent. Alternatively, when each winding segment 151 is shaped to have a substantially Z-shape, one of the link portions of the corresponding winding segment 151 at one of the first and the second ends may be bent toward the radially inward or radially outward, and the other of the link portions may be bent toward the opposite direction of the one of the link portions. In any case, the insulating covers, each of which covers over a corresponding one of the link portions, may preferably cause the coil modules 150 to be secured to the core assembly CA.

In the above structure, all the winding segments 151 for each phase winding are connected in parallel to each other, but this may be modified as follows. Specifically, all the winding segments 151 for each phase may be divided into plural parallel-connection groups in which the winding segments 151 are connected in parallel to each other, and the parallel-connection groups may be connected in series to each other. For example, all n winding segments 151 for each phase may be divided into two parallel-connection groups in which n/2 winding segments 151 are connected in parallel to each other, and the two parallel-connection groups may be connected in series to each other. As another example, all n winding segments 151 for each phase may be divided into three parallel-connection groups in which n/3 winding segments 151 are connected in parallel to each other, and the three parallel-connection groups may be connected in series to each other. Moreover, all the winding segments 151 for each phase winding are connected in series to each other.

The stator winding 61 of the rotating electrical machine 10 may be comprised of two-phase windings, such as U-phase winding and a V-phase winding. In this example, the pair of intermediate conductor portions 152 of each phase winding are arranged one coil pitch away from each other. This arrangement of the pair of intermediate conductor portions 152 of each phase winding enables one intermediate conductor portion 152 of the other phase winding to be arranged between the pair of intermediate conductor portions 152 of the corresponding phase winding.

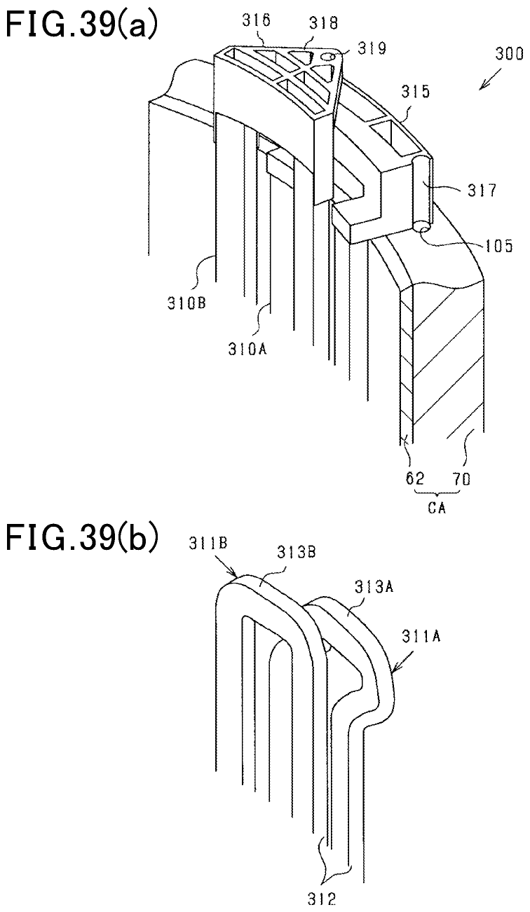

Although the rotating electrical machine 10 is designed as an outer-rotor surface-magnet rotating electrical machine, but however, may be designed as an inner-rotor surface-magnet rotating electrical machine. FIGS. 39(a) and 39(b) are views illustrating the structure of the stator unit 300 of the inner-rotor surface-magnet rotating electrical machine; the stator unit 300 is comprised of coil modules 310A and 310B. Specifically, FIG. 39(a) is a perspective view of the assembly of the core assembly CA and the coil modules 310A and 310B assembled to the inner peripheral surface of the core assembly CA. FIG. 39(b) is a perspective view of the winding segment 311A included in the coil module 310A and the winding segment 311B included in the coil module 310B. The inner-rotor surface-magnet rotating electrical machine is configured such that the stator holder 70 is assembled to the outer peripheral surface of the stator core 62 so that the core assembly CA is constructed. Additionally, the coil modules 310A and 310B are assembled to the inner peripheral surface of the stator core 62.

The winding segment 311A has substantially the same structure as that of the first winding segment 151A. Specifically, the winding segment 311A is comprised of a pair of intermediate conductor portions 312, and a pair of link portions 313A. Each of the link portions 313A is bent to extend radially outward toward the core assembly CA. The second winding segment 311B has substantially the same structure as that of the second winding segment 151B. Specifically, the winding segment 311B is comprised of a pair of intermediate conductor portions 312, and a pair of second link portions 313B. Each second link portion 313B circumferentially intersects with a part of the corresponding first link portion 313A at the axially outer side of the corresponding first link portion 313A. The insulating cover 315 is mounted to cover over each link portion 313A of the winding segment 311A. The insulating cover 316 is mounted to cover over each link portion 313B of the winding segment 311B.

The insulating cover 315 has opposing first and second circumferential sides, and the semi-circular recess 317 formed in each of the first and second circumferential sides thereof. The insulating cover 316 has the protrusion 318 extending radially outward. The protrusion 318 has an extending end, and a through hole 3019 formed through the extending end thereof.

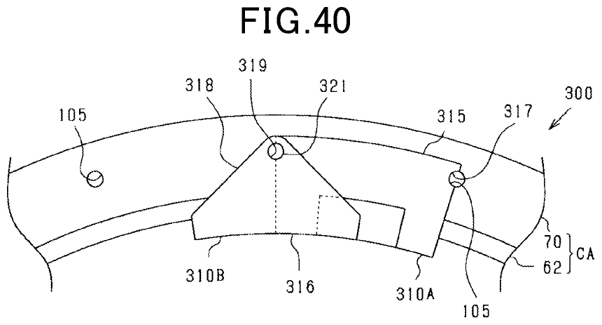

FIG. 40 is a plan view illustrating that the first and second coil modules 310A and 310B are assembled to the core assembly CA. The stator holder 70, as illustrated in FIG. 40, has a plurality of recesses 105 formed in the end surface of each of the first and second ends in the axial direction. The recesses 105 are circumferentially arranged at regular intervals away from each other. The stator holder 70 has a cooling mechanism using liquid coolant or air. For example, the stator holder 70 may have, as an air-cooling mechanism, a plurality of fins mounted to the outer peripheral surface thereof.

Each insulating cover 316 is, as clearly illustrated in FIG. 40, axially overlapped with a corresponding circumferentially adjacent pair of insulating covers 315 while

(1) The through hole 319, which serves as a second engagement portion, formed in the corresponding insulating cover 316 at a circumferentially center thereof is axially aligned with a corresponding pair of recesses 317, which serves as second engagement portions, formed in the corresponding circumferentially adjacent pair of insulating covers 315,

(2) The fastening pin 321 is fit in the through hole 319 of each insulating cover 316 and the corresponding pair of recessed grooves 317 formed in the corresponding circumferentially adjacent pair of insulating covers 315, so that each insulating cover 316 and the corresponding circumferentially adjacent pair of insulating covers 315 are fastened to each other by the fastening pin 321.

Each fastening pin 321 is, as can be seen in FIG. 40, fit through the corresponding through hole 319 of the corresponding insulating cover 316 and the corresponding through hole formed by the recesses 317 of the insulating covers 315. This results in

(1) The insulating covers 315 and 316 being fixedly mounted to each of the first and second outer surfaces of the stator holder 70 in the axial direction; the stator holder 70 is located radially outside the stator core 62,

(2) The insulating covers 315 and 316 being fastened by the fastening pins 321.

The stator holder 70 is equipped with the coolant mechanism is, so that heat generated from the first winding segments 311A and 311B is likely to be transferred to the stator holder 70. The above configuration of the rotating electrical machine 10, therefore, has a higher performance of cooling the stator winding 61.

The stator 60 included in the rotating electrical machine 10 may include protrusions, such as teeth, protruding from its back yoke. In this modification, the coil modules 150 or other components may be assembled to the back yoke of the stator 60.

The rotating electrical machine 10 has a star-connection wiring structure, but however, may alternatively configured to have a delta-connection (A-configuration) wiring structure.

The rotating electrical machine 10, which is designed as a revolving-field type rotating electrical machine comprised of a rotor working as a magnetic field generator, and a stator working as an armature, but may be designed as a revolving armature type of rotating electrical machine comprised of a rotor working as an armature, and a stator serving as a magnetic field generator.

### Second Modification

The winding segments in the above-described embodiments and modifications may be modified in the following ways. Each of the first winding segments 151A is made by bending coil ends of a winding segment equivalent to the second winding segment 151B in the radial direction and, thus, has substantially the same structure as that of the second winding segment 151B. The following discussion will, therefore, refer to the winding segments 701 in detail which basically have the same structures as those of the second winding segments 151B. Modified forms of the winding segments 701 which correspond to the first winding segments 151A will be omitted here. This modification mainly refers to parts different from those already discussed in the above embodiments and modifications. A rotating electrical machine, as referred to in this modification, is basically identical in structure with the rotating electrical machine 10 in the first embodiment.

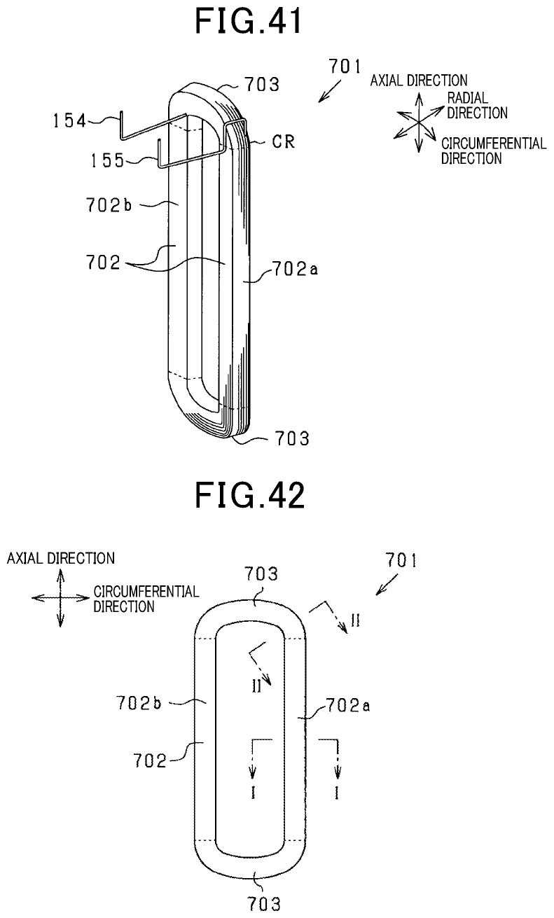

The stator winding 61 in this modification will be described below. The stator winding 61, like the stator winding 61 described in the first embodiment or using FIG. 16, includes a plurality of winding segments 701 each of which is made by winding the conductor wire member CR into an annular shape. The winding segments 701 are connected in parallel to or series with each other to complete the stator winding 61. Each of the winding segments 701, as shown in FIG. 41, includes a pair of intermediate conductor portions 702 (which will also be referred to as a pair of straight portions) and a pair of link portions 703, like the winding segments 151 discussed in the first embodiment using FIGS. 18 to 25.

The intermediate conductor portions 702 are arranged at given intervals away from each other in the circumferential direction. The intermediate conductor portions 702 face the magnet unit 22 in the radial direction of the rotor 20 and extend straight in the axial direction of the rotor 20. The intermediate conductor portions 702 overlap the stator core 62 in the radial direction.

The link portions 703 are arranged to connect the paired intermediate conductor portions 702 together. Specifically, the paired intermediate conductor portions 702 include the first intermediate conductor portions 702a and the second intermediate conductor portions 702b located at a given interval away from the first intermediate conductor portions 702a in the circumferential direction of the stator winding 61. The link portions 703 connect axial ends, as indicated by broken lines in FIG. 41, of the first and second intermediate conductor portions 702a and 702b together.

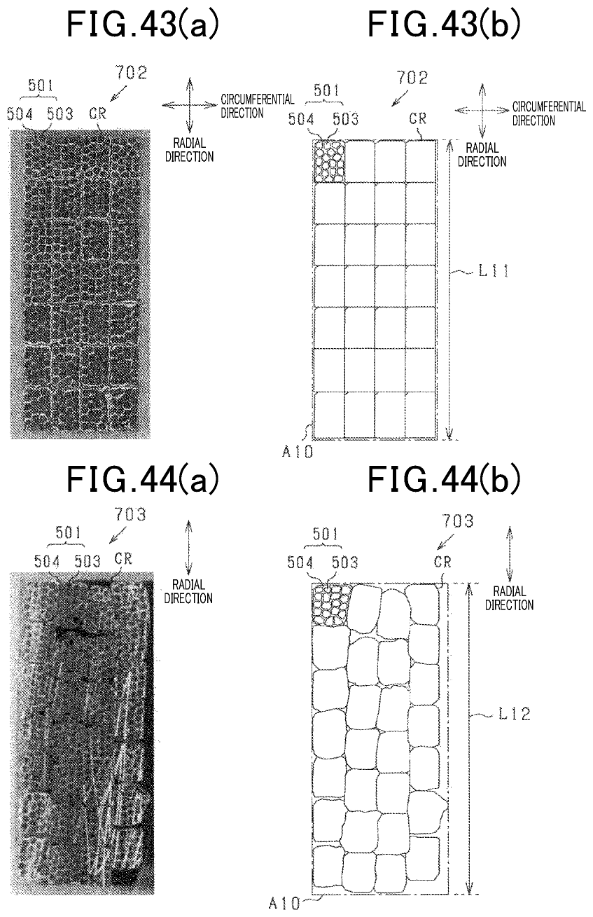

The winding segment 701 is, as described already, made by winding the conductor wire member CR multiple times to have substantially a square transverse section. Specifically, the winding segment 701 is made of a winding of the conductor wire member CR which has the intermediate conductor portions 702 each of which is, as illustrated in FIGS. 43(a) and 43(b), formed by a plurality of segments (i.e., turns), which will also be referred to as conductor segments, of the conductor wire member CR which are arranged adjacent to each other in the circumferential and radial directions. In other words, each of the intermediate conductor portions 702 of the winding segment 701 is made up of a plurality of turns of the conductor wire member CR which are arranged adjacent to each other in the radial direction and a plurality of layers of the turns of the conductor wire member CR stacked on one another in the circumferential direction, so that each of the intermediate conductor portions 702 has substantially a rectangular transverse section. To say it in a different way, each of the intermediate conductor portions 702 is made of a plurality of layers (i.e., rows) of the conductor segments (i.e. the turns) of the conductor wire member CR and a plurality of columns of the conductor segments of the conductor wire member CR.

Each of the intermediate conductor portions 702 of the winding segment 701 in this modification, as can be seen in FIGS. 43(a) and 43(b), includes seven columns of the conductor segments of the conductor wire member CR which are arranged adjacent to each other in the radial direction and four layers of the conductor segments of the conductor wire member CR which are arranged adjacent to each other in the circumferential direction. FIG. 43(a) is a cross-sectional view taken along the line I-I in FIG. 42. FIG. 43(b) is a diagrammatic sectional view which schematically illustrates outlines of the conductor segments of the conductor wire member CR shown in FIG. 43(a). FIG. 44(a) is a cross-sectional view taken along the line II-II in FIG. 42. FIG. 44(b) is a diagrammatic sectional view which schematically illustrates outlines of the conductor segments of the conductor wire member CR shown in FIG. 44(a).

In order to enhance the space factor in the intermediate conductor portions 702, it is advisable that the conductor segments of the conductor wire member CR be arranged adjacent to each other with a minimized gap therebetween. In this modification, the conductor wire member CR is shaped to have a rectangular transverse section to have the conductor segments arranged adjacent to each other with almost no air gap therebetween. In other words, the conductor segments (i.e., turns) of the conductor wire member CR are arranged in direct contact between side surfaces thereof.

The conductor wire member CR is shaped to have a rectangular transverse section, but may be designed to have any other shape, such as polygonal, circular, or square. The conductor wire member CR is made of a bundle of a plurality of wires 501.

Each of the wires 501 is made up of the conductive body 503 through which electrical current flows and the fusing layer 504 wrapped around the outer surface of the conductive body 503. The conductive body 503 may be made from a conductive metal, such as copper. The conductive body 503 is shaped to have a hexagonal transverse section, but however, may alternatively be designed to have any other shaped transverse section, such as round, polygonal, or oval. The fusing layer 504 is made from an electrically insulating material. In other words, the wires 501 are self-fused together using the fusing layers 504 which are made from resin working as an electrical insulator. The fusing layers 504 may alternatively be made of an insulating layer and a fusing layer.

In the bundle of the wires 501, the fusing layers 504 are welded together to firmly adhere the adjacent wires 501 together in contact with each other. Such a firm joint between the adjacent wires 501 minimizes physical vibration or undesirable noise arising from rubbing of the wires 501. The wires 501 are collected in the form of a bundle with the fusing layers 504 welded together, thereby ensuring the stability in keeping the configuration of the conductor wire member CR. The fusing layers 504 also work to achieve electrical insulation between the circumferentially or radially overlapping conductor segments of the conductor wire member CR or between the conductor wire member CR and the stator core 62.

The conductor wire member CR may alternatively be made of the bundle of wires 501 and an insulating coating wrapped around the outer periphery of the bundle. The insulating coating may be made in a wide insulating or alternatively be molded using resin.

The link portions 703 are, as described above, shaped to connect between the axial ends of the first intermediate conductor portions 702a and the second intermediate conductor portions 702a arranged at a given interval away from the first intermediate conductor portion 702a in the circumferential direction. Each of the link portions 703, therefore, has bends defined by sections extending in the axial direction and sections extending in the circumferential direction.

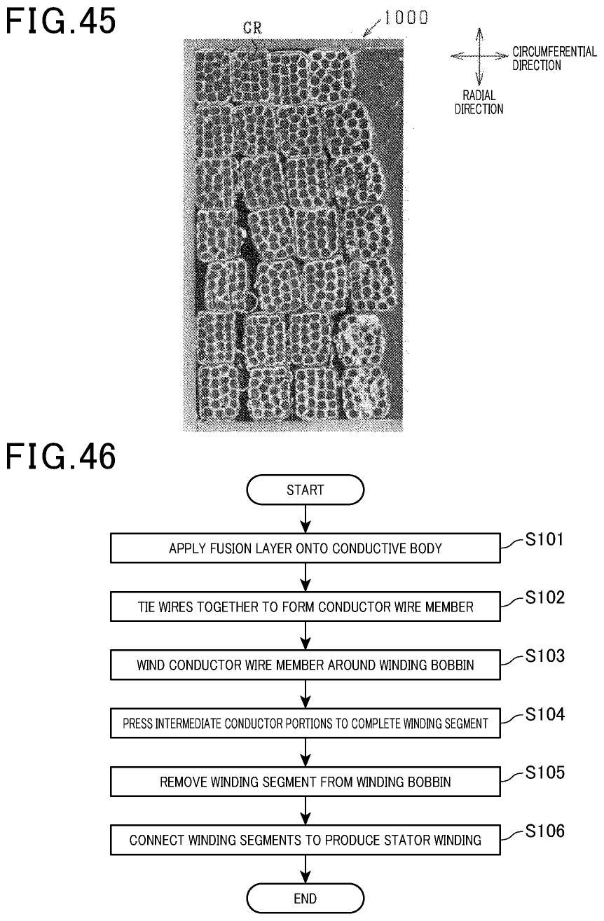

Each of the link portions 703 is made of a plurality of conductor segments (i.e., portions of turns) of the conductor wire member CR. Bending the link portions 703, therefore, results in slant orientation or distortion of the conductor segments of the link portions 703, which will be transmitted to the intermediate conductor portions 702. This, as demonstrated in a comparative example of the intermediate conductor portion 1000 in FIG. 45, results in disorder or misalignment of the conductor segments of the conductor wire member CR, thereby creating air gaps among the conductor segments and also leading to increased deformation of the configuration of the bundle of the wires 501.

It is known experientially that the above phenomenon usually appears to be significant in a case where the conductor wire member CR is made of the bundle of wires 501 or the conductor segments of the conductor wire member CR are arranged close to each other in the link portions 703 without any air gaps therebetween. It is also found that an increase in distortion or slant orientation of the conductor segments of the link portions 703 will result in an increase in disorder or misalignment of the conductor segments of the conductor wire member CR in the intermediate conductor portions 1000 on the circumferentially outer side (i.e., the right side in FIG. 45).

In order to alleviate the above drawback, the link portions 703 are designed to have a space factor (i.e., stacking factor) lower than that of the intermediate conductor portions 702. In other words, as compared with the intermediate conductor portions 702 shown in FIGS. 43(a) and 43(b), the conductor wire member CR is, as demonstrated in FIGS. 44(a) and 44(b), wound loosely in the link portions 703 to reduce the transmission of the slant orientation or distortion of the conductor segments of the conductor wire member CR in the link portions 703 to the intermediate conductor portions 702 leading to the link portions 703.

Specifically, each of the link portions 703 is shaped to have a dimension L12 in the radial direction which is larger than a dimension L11 of each of the intermediate conductor portions 702 in the radial direction. The radial dimension L12 of the link portions 703 is an average of dimension of the whole of the link portions 703 as measured in the radial direction. Similarly, the radial dimension L11 of the intermediate conductor portions 702 is an average of dimension of the whole of the intermediate conductor portions 702 as measured in the radial direction. Each of the link portions 703 is preferably shaped to have a dimension in the circumferential direction which is minimized on a radial inner side thereof. For the sake of convenience, FIGS. 43(a), 43(b), 44(a), and 44(b) illustrate portions of the winding segment 701 where the dimensions L11 and L22 are maximized.

The space factor will be described below. The space factor, as referred to herein, is derived by dividing the sum of sectional areas of the conductive bodies 503 lying within a rectangular region A10 enclosing a transverse section of the winding segment 701 by an area of the rectangular region A10. How to define the region A10 will be discussed. First, a first one of sides of the region A10 is, as demonstrated by alternate long and short dash lines in FIGS. 43(b) and 44(b), set to agree with a maximum dimension of a transverse section of the winding segment 701 in the radial direction. Next, a second one of the sides of the region A10 is set to agree with a maximum dimension (i.e., a maximum width) of the transverse section of the winding segment 701 in a direction perpendicular to the radial direction. The first and second sides are used to define the region A10. In other words, the region A10 is selected to have the transverse section of the winding segment 701 just lying therein. An angle which the adjacent sides of the region A10 make with each other is selected to be 90°.

The transverse section of the winding segment 701, as referred to herein, is a cross-section thereof taken in a direction perpendicular to a direction in which the conductor wire member CR extends. For instance, portions of the conductor wire member CR which define the intermediate conductor portions 702 extend in the axial direction. The cross-sections of the intermediate conductor portions 702 are, therefore, provided by cross-sections of the winding segment 701 taken in a direction which is perpendicular to the axial direction and parallel to the radial and circumferential directions.

The transverse section of the winding segment 701, as referred to herein, may be a cross-section of an optional portion of thereof. For instance, the transverse section of each of the link portions 703 may be a cross-section of a portion thereof which is the smallest in radius of curvature (i.e., bending radius) or alternatively extends straight. The transverse section of each of the intermediate conductor portions 702 may be a cross-section of an optional portion thereof extending in the axial direction.

When it comes to comparison of space factors, an average space factor in the link portions 703 may be compared with an average space factor in the intermediate conductor portions 702. Alternatively, a maximum value of a space factor in the link portions 703 may be compared with a minimum value of a space factor in the intermediate conductor portions 702.

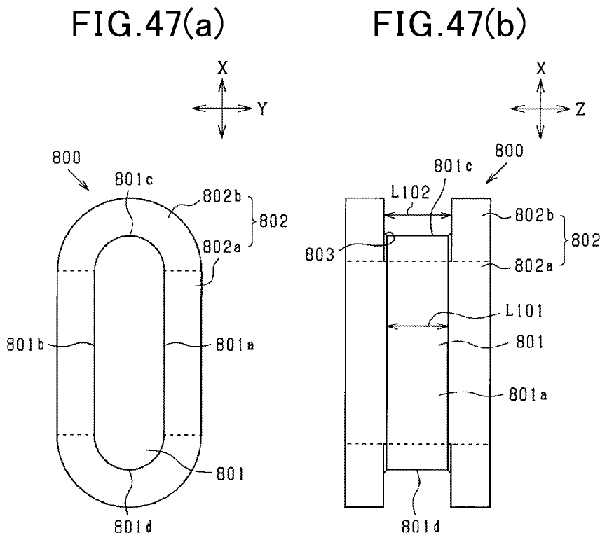

A production method of the rotating electrical machine 10, especially the stator winding 61 will be described below with reference to FIGS. 46 to 48(b). FIG. 46 is a flowchart of a sequence of steps of the production method. FIGS. 47(a) and 47(b) are views which illustrate the winding bobbin 800 around which the conductor wire member CR is wound. The winding bobbin 800 will be described below in detail.

First, the conductor body 503 are taken from a plurality of cylindrical bobbins (i.e., reels) around which the linear conductive body 503 are wound. Simultaneously, the fusing layer 504 are applied onto the surfaces of the respective conductive body 503 (step S101). Alternatively, the wires 501 each of which has the fusing layer 504 coated on the conductive body 503 may be wound around bobbins in advance. Subsequently, the wires 501 may be taken from the bobbins.

The wires 501 are collected or tied together to make the conductor wire member CR (step S102). In step S102, the fusion layers of the wires 501 are placed in contact with each other and adhered together. Additionally, each of the wires 501 is stretched into a linear form. Alternatively, before being tied together, the wires 501 may be stretched into a linear form prior to step S102. The operations in step S102 will also be referred to as a conductor making process. In step S102, a wide insulating tape may also be wrapped around the outer periphery of the conductor wire member CR in the form of an insulating layer. Alternatively, the insulating layer may be formed on the conductor wire member CR using resin-molding techniques. After being tied together, the wires 501 may be compressed into a required shape of transverse sections of the wires 501.

Subsequently, the conductor wire member CR is wound around the winding bobbin 800 several times to fabricate each of the winding segments 701 (step S103). The winding bobbin 800, as can be seen in FIGS. 47(a) and 47(b), includes the cylinder 801 and a pair of flanges 802 disposed on opposed ends of the cylinder 801.

The cylinder 801 is shaped to have a rectangular cross-section with round corners (i.e., an oval cross-section in this modification). Specifically, the cylinder 801 has a side surface which includes a pair of flat surfaces 801a and 801b and a pair of end surfaces 801c and 801d. The flat surfaces 801a and 80b face each other and extend parallel to each other. Each of the end surfaces 801c and 801d connects an end of the flat surface 801a and an end of the flat surface 801b together. Each of the end surfaces 801c and 801d is shaped in the form of a curve extending from the end of the flat surface 801a to the end of the flat surface 801b. In other words, each of the end surfaces 801c and 801d has a semi-circular cross-section. The cylinder 801 may be hollow or in a solid columnar shape.

In the following discussion of the second modification, a direction in which the cylinder 801 extends will be, as demonstrated in FIGS. 47(a) and 47(b), referred to as a Z-axis direction. A direction which is perpendicular to the Z-axis direction and parallel to long sides of the flat surfaces 801a and 801b will also be referred to as an X-axis direction. A direction which is perpendicular to the Z-axis and X-axis directions, in other words, vertical to the flat surfaces 801a and 801b will be referred to as a Y-axis direction. The flat surfaces 801a and 801b of the cylinder 801 are shaped to have dimensions identical with those of the end surfaces 801c and 801d in the Z-axis direction.

The flanges 802 are each made of an annular flat plate. The flanges 802 are arranged on the opposed ends (i.e., the right and left ends, as viewed in FIG. 47(b)) of the cylinder 801 and protrude outside the ends of the cylinder 801 in a direction perpendicular to the Z-axis direction. The flanges 802 face each other in the Z-axis direction.

The distance L102 that is an interval between portions of the flanges 802 coinciding with each of the end surfaces 801c and 801 d of the cylinder 801 in the Z-axis direction is selected to be longer than the distance L101 that is an interval between portions of the flanges 802 coinciding with each of the flat surfaces 801a and 801b of the cylinder 801 in the Z-axis direction.

The portions of the flanges 802 coinciding with the flat surfaces 801a and 801b of the cylinder 801, as referred to herein, are the straight portions 802a which are arranged on sides of the flat surfaces 801a and 801b which are opposed to each other in the Z-axis direction. In other words, the straight portions 802a are portions of the flanges 802 which protrude from the flat surfaces 801a and 801b. The straight portions 802a are arranged to extend parallel to each other. The straight portions 802a of the paired flanges 802 are, therefore, arranged away from each other at the same distance (i.e., the distance L101) continuously between them.

The distance L101 between the opposed straight portions 802a is selected to be substantially identical with the product of a width of the conductor wire member CR measured in the Z-axis direction and the number of turns (i.e., the columns) of the conductor wire member CR which are arranged adjacent to each other in the radial direction. For instance, in the winding segment 701 demonstrated in FIGS. 41 to 44(b), the product of the width of the conductor wire member CR in the Z-axis direction and the number of turns in each layer, that is, seven is equal to the distance L101 between the straight portions 802a. The width of each of the flanges 802 (i.e., the straight portions 802a) that is a distance between the cylinder 801 and an outer edge of the flange 802 is selected to be greater than the product of the width of the conductor wire member CR in the circumferential direction and the number of layers of turns of the conductor wire member CR stacked on one another in the circumferential direction. For instance, in the winding segment 701 illustrated in FIGS. 41 to 44(b), the width of each of the flanges 802 (i.e., the straight portions 802a) that is an interval between the cylinder 801 and the outer edge of the flange 802 is selected to be greater than the product of the width of the conductor wire member CR measured in the Y-axis direction and four (i.e., the number of the layers of turns of the conductor wire member CR).

The portions of the paired flanges 802 which coincide with the end surfaces 801c and 801d of the cylinder 801, as referred to herein, are the semicircular portions 802b which are arranged on sides of the end surfaces 801c and 801d which are opposed to each other in the Z-axis direction. In other words, the semicircular portions 802b are portions of the flanges 802 which protrude outside the end surfaces 801c and 801d. The interval between the opposed semicircular portions 802b excluding inside portions thereof (i.e., the tapered surfaces 803 which will be described later in detail) which are located close to the cylinder 801 is determined to be a given distance which is identical with the above-described distance L102 between the semicircular portions 802b. The distance L102 between the semicircular portions 802b, as referred to in the second modification, is an interval between places located at a given distance away from the cylinder 801 (see FIG. 47(b)). In the second modification, the distance L102 between the semicircular portions 802b is selected to be a value derived by multiplying the width of the conductor wire member CR in the Z-axis direction by 7.5.

The width of each of the semicircular portions 802b is selected to be greater than the product of the width of the conductor wire member CR in the circumferential direction and the number of layers of turns of the conductor wire member CR stacked on one another in the circumferential direction. For instance, in the winding segment 701 illustrated in FIGS. 41 to 44(b), the width of each of the semicircular portions 802b is set to be greater than the product of the width of the conductor wire member CR measured in the Y-axis direction and four (i.e., the number of the layers of turns of the conductor wire member CR) in the circumferential direction.

The above-described tapered surfaces 803 which partially occupy inner peripheries of the semicircular portions 802b will be described below. Specifically, the inner peripheral surface of each of the semicircular portions 802b which faces the cylinder 801 in the Z-axis direction has the tapered surface 803. The tapered surfaces 803 are shaped to an interval therebetween which decreases toward the cylinder 801. More specifically, the interval between the opposed tapered surfaces 803 is set to decrease from the distance L102 between the semicircular portions 802b gradually to the distance L101 between the straight portions 802a. The semicircular portions 802b may alternatively be designed not to have the tapered surfaces 803. In other words, the straight portions 802a and the semicircular portions 802b may be shaped to have a stepwise shoulder therebetween.

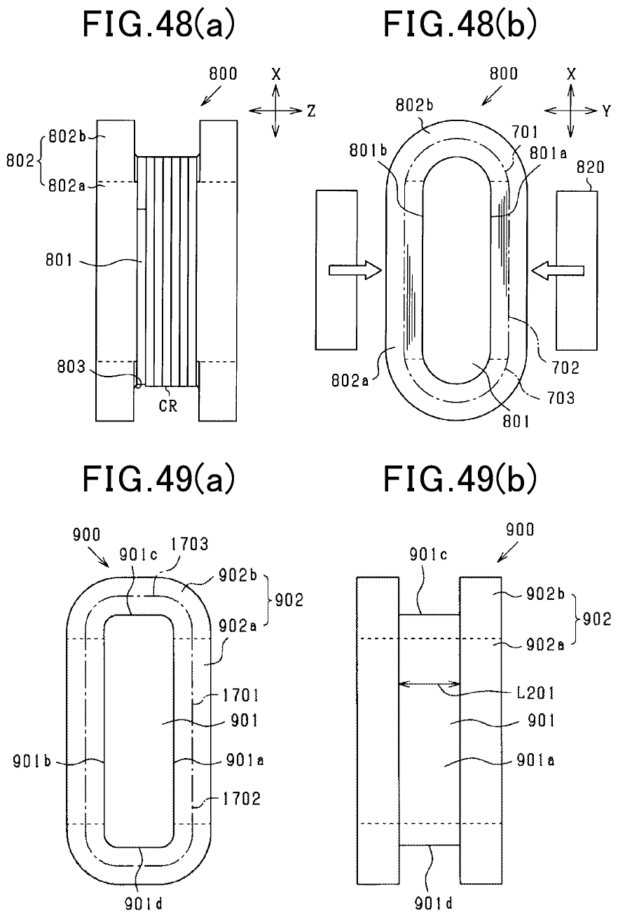

Referring back to the flowchart in FIG. 46, in step S103, the conductor wire member CR is, as described already, wound around the cylinder 801 of the winding bobbin 800 until several turns (seven turns in this modification) are, as demonstrated in FIG. 48(a), produced and arranged adjacent to each other in the Z-axis direction to make a first layer of the conductor wire member CR. Subsequently, the conductor wire member CR continues to be looped over the first layer of the conductor wire member CR to produce the second layer in the same way as making the first layer until several turns, also called several columns, (seven columns in this modification) are produced and arranged adjacent to each other in the Z-axis direction. When the odd-numbered layer (e.g., the first or third layer) is produced, a direction in which the conductor wire member CR is wound and moved to make an array of turns (e.g., the first or third layer) is opposite that in which the conductor wire member CR is wound and moved to make the even-numbered layer (e.g., the second or fourth layer). The above operations are repeated until the given number of layers (i.e., four layers in this modification) are stacked on one another.

The conductor wire member CR is wound around the winding bobbin 800 in the above way, thereby forming the intermediate conductor portions 702 in a region enclosed by the flat surfaces 801a and 801b of the cylinder 801 and the straight portions 802a of the flanges 802. The link portions 703 are also produced in a region enclosed by the end surfaces 801c and 801d of the cylinder 801 and the semicircular portions 802b of the flanges 802. The operation in step S103 will also be referred to as a winding segment making process.

The winding of the conductor wire member CR around the winding bobbin 800 is achieved with application of a given degree of tension to the conductor wire member CR to avoid twist of the intermediate conductor portions 702. In other words, the winding of the conductor wire member CR is made to have portions of the turns of the conductor wire member CR which form each of the intermediate conductor portions 702 and are arranged to have sides thereof located in as close contact with each other as possible.

After the operation in step S103, ends of the winding of the conductor wire member CR around the winding bobbin 800 which are opposed to each other in the Z-axis direction are compressed, thereby completing the winding segment 701 (step S104). In step S104, the press members 820 which, as clearly illustrated in FIG. 48(b), have flat surfaces contoured to conform with the flat surfaces 801a and 801b of the cylinder 801 are used to press portions of the turns of the conductor wire member CR which form the intermediate conductor portions 702 and are stacked on one another in the Y-axis direction perpendicular to the flat surfaces 801a and 801b. This corrects the undesirable orientation or twist of the turns of the conductor wire member CR which form the intermediate conductor portions 702 to minimize air gaps between the turns of the conductor wire member CR. This completes the winding segment 701. The operation in step S104 will also be referred to as a pressing process. The production of the winding segment 701 may be achieved without step S104.

After step S104, the winding segment 701 is removed from the winding bobbin 800 (Step S105). The winding bobbin 800 is designed to have the flanges 802 detachable from the cylinder 801. After the flanges 802 are withdrawn from the cylinder 801, the winding segment 701 is pulled in the Z-axis direction so that it is removed from the cylinder 801.

After a given number of winding segments 701 are produced, they are joined together and arranged adjacent to each other in the circumferential direction of the rotor 20 to complete the stator winding 61 (step S106). The operation in step S106 will also be referred to as an armature winding producing process.

The difference between the winding segment 701 in this modification and the winding segment 1701 produced by the winding bobbin 900, as illustrated as a comparative example in FIGS. 49(a) and 49(b), will be discussed below based on a comparison between the structures of the winding bobbin 800 and the winding bobbin 900. The winding bobbin 900 in the comparative example illustrated in FIGS. 49(a) and 49(b) includes, like the winding bobbin 800, the cylinder 901 and a pair of flanges 902 secured to opposed ends of the cylinder 901.

The cylinder 901 is, like the winding bobbin 800, shaped to have a rectangular cross-section and includes a pair of flat surfaces 901a and 901b and end surfaces 901c and 901d. The end surfaces 901c and 901d, unlike the end surfaces 801c and 801d of the winding bobbin 800, have only corners round, but other sections flat.

Specifically, each of end surfaces 901c and 901d has the round corners whose radii of curvature are smaller than those of the end surfaces 801dc and 801d in the second modification. The flanges 802 are, as clearly illustrated in FIG. 49(b), located at a constant distance L201 away from each other.

As compared with the winding segment 1701 fabricated using the winding bobbin 900 in the comparative example, the winding segment 701 formed using the winding bobbin 800 has the link portions 703 whose size is large and which are made of turns of the conductive wire member CR which are arranged at a large interval away from each other. In other words, the winding segment 701 produced using the winding bobbin 800 in the second modification has the link portions 703 whose widths are larger than those of the intermediate conductor portions 702 in the radial direction.

The winding segment 1701 fabricated using the winding bobbin 900 has the intermediate conductor portions 1702 and the link portions 1703 whose widths are substantially identical with each other in the radial direction, however, it faces a risk that the thickness of each of the intermediate conductor portions 1702 in the Y-axis direction may be increased due to undesirable orientation or twist of the turns of the conductor wire member CR as compared with the winding segment 701 in the second modification.

The winding segment 701 produced using the winding bobbin 800 is small in degree of undesirable orientation or twist of the turns of the link portions 703 since the radius of curvature of each of the end surfaces 801c and 801d of the winding bobbin 800 is larger than that in the winding segment 1701. In contrast, the winding segment 1701 produced using the winding bobbin 900 has an increased risk that the degree of undesirable orientation or twist of the turns of the link portions 1703 since the radius of curvature of each of the end surfaces 901c and 901d of the winding bobbin 900 is smaller than that in the winding bobbin 800, thereby resulting in an increased degree of undesirable orientation or twist of the turns of the intermediate conductor portions 1702.

The space factor in the intermediate conductor portions 702 of the winding segment 701 fabricated using the winding bobbin 800 in the second modification is, therefore, higher than that in the intermediate conductor portions 1702 of the winding segment 1701 fabricated using the winding bobbin 900 in the comparative example.

The second modification offers the following beneficial advantages.

Each of the link portions 703 is used to connect between the axial end of the first intermediate conductor portion 702a that is one of the paired intermediate conductor portions 702a and the axial end of the second intermediate conductor portion 802a that is the other of the paired intermediate conductor portions 702a located at a given interval away from the first intermediate conductor portion 702a in the circumferential direction. Each of the link portions 703 is, therefore, shaped to have some portion(s) which bends from the axial direction to the circumferential direction. Each of the link portions 703 is made up of a plurality of turns of the conductor wire member CR. Bending a portion of the link portion 703 may, therefore, cause incorrect orientation or deformation of the turns of the conductor wire member CR which form the link portion 703 to be transmitted to the intermediate conductor portions 702, thereby resulting in disorder of the turns of the conductor wire member CR which form the intermediate conductor portions 702, which will lead to air gaps among the turns. Such a phenomenon usually prominently appears in the conductor wire member CR made of a bundle of the wires 501. It is also experientially found that the above phenomenon will occur in a case where the turns of the conductor wire member CR are arranged in close contact with each other in the link portions 703.

The link portions 703 are each designed to have a space factor lower than that of the intermediate conductor portions 702. In other words, the conductor wire member CR is wound loosely in the link portions 703 in order to minimize the transmission of incorrect orientation or deformation of the turns of the conductor wire member CR in the link portions 703 to the intermediate conductor portions 702 continuing from the link portions 703. This permits the conductor wire member CR to be wound tightly in the intermediate conductor portions 702 to eliminate air gaps among the turns of the conductor wire member CR in the intermediate conductor portions 702, thereby resulting in an increase in space factor in the intermediate conductor portions 702 facing the magnet unit 22. Further, the link portions 703 have increased sizes of air gaps among the turns of the conductor wire member CR, thereby enhancing the cooling of the link portions 703 using air or water.

Each of the link portions 703 is of an arc shape entirely curved from end to end thereof, thereby resulting in an increased radius of curvature which is larger than that in the case where the link portions 703 are only partially curved or bent, which minimizes the transmission of the incorrect orientation or deformation of the turns of the conductor wire member CR from the link portions 703 to the intermediate conductor portions 702 and enables the conductor wire member CR to be wound tightly to have increased numbers of columns and layers of turns in the intermediate conductor portions 702.

The above configuration of the link portions 703 enables an outer peripheral portion located away from the cylinder 801 to have a radius of curvature larger than that of an inner peripheral portion thereof. This also serves to reduce the transmission of incorrect orientation or deformation of the turns of the conductor wire member CR from the link portions 703 to the intermediate conductor portions 702, thereby enhancing the minimization of disorder of the turns of the outer peripheral portions of the intermediate conductor portions 702.

The radial dimension L12 of each of the link portions 703 is set larger than the radial dimension L11 of the intermediate conductor portions 702, thereby enabling the dimension of the winding segment 701 to be minimized in the axial direction and the space factor to be reduced in the link portions 703.

The radial dimension L12 of each of the link portions 703 in the second modification is selected to increase from an inner peripheral portion to an outer peripheral portion of the link portion 703, thereby resulting in an increased risk that air gaps may be produced among the turns of the outer peripheral portions of the link portions 703, which enhances the reduction in disorder of the turns in the outer peripheral portions of the intermediate conductor portions 702.

The conductor wire member CR, as described above, has a rectangular cross-section, so that the turns of the conductor wire member CR are arranged adjacent to each other in close contact between sides thereof in the intermediate conductor portions 702, thereby facilitating the ease with which air gaps among the turns in the intermediate conductor portions 702 can be reduced in size to increase the space factor in the intermediate conductor portions 702 as compared with the case where the conductor wire member CR is designed to have a circular cross-section.

The winding bobbin 800 is, as described above, designed to have the distance L102 larger than the distance L101. The distance L102 is an interval between the semicircular portions 802b of the flanges 802 coinciding with the end surfaces 801c and 801d of the cylinder 801 in the Z-axis direction. The distance L101 is an interval between the straight portions 802a of the flanges 802 coinciding with the flat surfaces 801a and 801b of the cylinder 801 in the Z-axis direction. The above configuration of the winding bobbin 800 facilitates the ease with which the conductor wire member CR is wound around the winding bobbin 800 several times to have the space factor in the link portions 703 which is lower than that in the intermediate conductor portions 702 of the winding segment 701.

The end surfaces 801c and 801d of the cylinder 801 are each curved entirely from the end of the flat surface 801a to the end of the flat surface 801b of the cylinder 801, thereby enabling the radii of curvature of the end surfaces 801c and 801d to be larger than those in the case where the link portions 703 are partially curved or bent, which facilitates the ease with which the transmission of incorrect orientation of deformation of the turns of the conductor wire member CR from the link portions 703 to the intermediate conductor portions 702 is reduced, in other words, the reduction in space factor in the link portions 703 to be lower than that in the intermediate conductor portions 702, and also enables the turns of the conductor wire member CR to be arranged in increased numbers of columns and layers in the intermediate conductor portions 702 without air gaps among the turns.

The semicircular portions 802b of each of the paired flanges 802 have the tapered surfaces 803 formed on inner surfaces thereof. An interval between the facing tapered surfaces 803 of the paired flanges 802 decreases as it approaches the cylinder 801. Specifically, the interval between the facing tapered surfaces 803 of the flanges 802 changes toward the cylinder 801 from the distance L102 between the semicircular portions 802b to the distance L101 between the straight portions 802a. This creates inner shoulders on the flanges 802 each of which is located between one of the semicircular portions 802b and a corresponding one of the straight portions 802a and which work to reduce the incorrect orientation or twist of the turns of the conductor wire member CR, thereby increasing the space factors in the intermediate conductor portions 702. The tapered surfaces 803 also serve to facilitate the ease with which the conductor wire member CR is wound around opposed ends of the cylinder 801. In other words, when the conductor wire member CR is looped and moved from each of the semicircular portions 802b toward a corresponding one of the straight portions 802a of the winding bobbin 800, each tapered surface 803 functions to guide the conductor wire member CR to a corresponding one of the flat surfaces 801a and 801b, thereby facilitating the winding of the conductor wire member CR around the cylinder 801 without being caught on the inner surfaces of the flanges 802.

After the conductor wire member CR is wound around the winding bobbin 800 several times, the layers of the turns of the conductor wire member CR stacked on the flat surfaces 801a and 801b of the cylinder 801 are, as described above, compressed in the Y-axis direction using the press members 820 having flat press surfaces. This corrects the incorrect orientation or deformation of the turns of the conductor wire member CR in the intermediate conductor portions 702, thereby decreasing the sizes of air gaps among the turns in the intermediate conductor portions 702 to enhance the space factors in the intermediate conductor portions 702.

The winding of the conductor wire member CR around the winding bobbin 800 is accomplished by arranging the turns of the conductor wire member CR in multiple columns and layers on the flat surfaces 801a and 801b of the cylinder 801 with the sides of the adjacent turns of the conductor wire member CR being placed in close contact with each other. This results in a decrease in size of air gaps among the turns in the intermediate conductor portions 702 and an increase in space factor in the intermediate conductor portions 702.

### Variation of Second Modification

The winding segment 701 and the winding bobbin 800 in the second modification may be designed to have structures as described below. This variation will refer only to parts different from those in the above embodiments or modifications. The following discussion will be made using, as an example, the structure in the second modification.

The space factor, as referred to in the second modification, may be determined based on the rectangular segment A10 which is defined by selecting an area of a region delimited by an outer periphery of the winding segment 701 and a boundary of the region A10 to be minimized. In other words, the region A10 may be defined to have sides extending non-parallel to the radial direction.

In the second modification, the end surfaces 801c and 801d of the cylinder 801 are curved entirely from end to end thereof, but however, may alternatively be shaped to have a linear section. For instance, the cylinder 801 may be shaped to have a rectangular transverse section with round corners.

The stator 60 in the above-described embodiment or modifications has no inter-conductor members between the intermediate conductor portions 152 or 702 arranged adjacent to each other in the circumferential direction, but however, may alternatively be designed to have non-magnetic material made inter-conductor members disposed between the intermediate conductor portions 152 or 702. For instance, as the inter-conductor members, magnetic material may be used which meets a relation of Wt×Bss≤Wm×Br where Wt is a width of the inter-conductor members in the circumferential direction within one magnetic pole, Bs is the saturation magnetic flux density of the inter-conductor members, Wm is a width of the magnets 32 equivalent to one magnetic pole in the circumferential direction, and Br is the remanent flux density in the magnet 32. For instance, the stator 60 may be designed to have toothed portions or protrusions which are extra-fine or extremely small not to function as conventional teeth usually used in stators. Accordingly, the conductive inter-conductor member which is disposed between a respective adjacent two of the intermediate conductor portions 152 or 702 functions as an electrostatic shield to reduce adverse effects arising from noise. It is advisable that each of the inter-conductor members be disposed to extend in the radial direction and isolate the intermediate conductor portions 152 or 702 from each other.

This disclosure in this application is not limited to the above-described embodiments. This disclosure includes the above embodiments and modifications which may be made by those of ordinary skill in the art. For instance, this disclosure is not limited to parts or combinations of the parts referred to in the embodiments, but may be realized using various combinations of the parts. This disclosure may include additional possible arrangements or omissions of the parts in the embodiments. This disclosure may include exchanges of the parts among the embodiments or combinations of the parts in the embodiments. Disclosed technical scopes are not limited to statements in the embodiments. It should be appreciated that the disclosed technical scopes include elements specified in the appended claims, equivalents of the elements, or all possible modifications of the elements without departing from the principle of this disclosure.

While this disclosure has referred to the preferred embodiments, it should be appreciated that the disclosure is not limited to the embodiments. This disclosure may include a variety of combinations of the embodiments, a combination of diverse modifications of the embodiments and equivalents thereof.

1. A rotating electrical machine comprising:
a magnetic field-producing unit including a magnet unit which is equipped with a plurality of magnetic poles whose polarities alternate in a circumferential direction of the magnet unit;
an armature which includes a multi-phase armature winding; and
a rotor which is implemented by one of the magnetic field-producing unit and the armature, wherein
the armature winding includes a plurality of winding segments each of which is made of a winding of a conductor wire member, the winding segments being arranged at a given interval away from each other in the circumferential direction and facing the magnet unit,
each of the conductor wire members is made of a bundle of a plurality of wires,
each of the winding segments includes a pair of straight portions and link portions, the straight portions extending straight in an axial direction of the rotor, the link portions connecting the straight portions together,
each of the straight portions includes turns of the conductor wire member which are arranged in multiple columns and layers, and
each of the link portions has a space factor lower than those in the straight portions.

2. The rotating electrical machine as set forth in claim 1, wherein each of the link portions is curved from end to end thereof.

3. The rotating electrical machine as set forth in claim 1, wherein each of the link portions has a dimension, as defined in a radial direction, which is larger than those of the straight portions.

4. The rotating electrical machine as set forth in claim 1, wherein each of the conductor wire members has a rectangular cross section, and the turns of the conductor wire member are arranged adjacent to each other in contact between sides thereof in each of the straight portions.

5. A production method of a rotating electrical machine which includes a magnetic field-producing unit including a magnet unit which is equipped with a plurality of magnetic poles whose polarities alternate in a circumferential direction of the magnet unit, an armature which includes a multi-phase armature winding, and a rotor which is implemented by one of the magnetic field-producing unit and the armature, the production method comprising:
a conductor making process which collects a plurality of wires in a form of a bundle to produce each conductor wire member;
a winding segment making process which winds each of the conductor wire members around a winding bobbin multiple times to produce each winding segment; and
an armature winding producing process which arranges the winding segments in a circumferential direction of the rotor and connects the winding segments to produce the armature winding, wherein
the winding bobbin includes a cylinder and a pair of flanges which are disposed on opposed ends of the cylinder to have a side surface of the cylinder arranged between the flanges,
the side surface of the cylinder includes a pair of flat surfaces which are opposed to each other and a pair of end surfaces each which connects an end of a first one of the flat surfaces and an end of a second one of the flat surfaces, and
a distance between portions of the flanges which coincide with the end surfaces of the cylinder is longer than a distance between portions of the flanges which coincide with each of the flat surfaces.

6. The production method as set forth in claim 5, wherein each of the end surfaces of the cylinder is shaped in form of a curve extending from an end of a first one of the flat surfaces to an end of a second one of the flat surfaces.

7. The production method as set forth in claim 5, wherein each of the flanges has tapered surfaces formed on portions thereof which coincide with one of the end surfaces of the cylinder, and wherein each of the tapered surfaces is shaped to have an interval between the flanges which decreases toward the cylinder.

8. The production method as set forth in claim 5, wherein the winding segment making process includes a pressing process which works to compress portions of turns of the conductor wire member arranged on the flat surfaces of the cylinder using flat press members in a direction perpendicular to the flat surfaces of the cylinder after the conductor wire member is wound multiple times around the winding bobbin.

9. The production method as set forth in claim 5, wherein each of the conductor wire member is shaped to have a rectangular cross section, and the winding segment making process works to arrange turns of the conductor wire member adjacent to each other in multiple columns and layers and place the turn to have sides thereof in contact with each other on the flat surfaces of the cylinder.
